(19) United States
(12) Patent Application Publication
(10) Pub. No.: US 2007/0137502 A1
(43) Pub. Date: Jun. 21, 2007

(54) MULTIPLE PHASE CONFECTIONERY ARTICLE AND SYSTEM AND METHOD FOR PREPARING SAME

(76) Inventor: Joan Fabre Fornaguera, Sant Cugat del Valles (ES)

Correspondence Address: BELL, BOYD & LLOYD LLP, P.O. Box 1135, CHICAGO, IL, 60690, US

(21) Appl. No.: 11/539,934

(22) Filed: Oct. 10, 2006

Related U.S. Application Data
(60) Provisional application No. 60/725,768, filed on Oct. 12, 2005.

(51) Int. Cl. A23P 1/00

(52) U.S. Cl. 99/450.1

(57) ABSTRACT

The present disclosure set forth a multiple phase confectionery article and methods and apparatus for producing the article. The confectionery article includes at least two strands of confectionery material, each confectionery material having a visually different property. Each strand extends across the width and through the thickness of the confectionery article. Precise delineation exists between the visually distinct strands. The apparatus and methods disclosed produce multiple phase intermediate confectionery products that may be sheeted and scored for preparation of the final multiple phase confectionery article.

### PRIORITY CLAIM

This patent application claims the benefit of U.S. Provisional Application No. 60/725,768, filed on Oct. 12, 2005.

### BACKGROUND

It is generally known that providing confectionery products in novelty shapes, compositions, and/or colors can lead to enhanced marketability, particularly with younger consumers. Pliable confectionery products, such as chewing gum for example, may be formed in the shape of sticks, pellets, and rolled tape in order to attract a wide array of different consumers. Conventional production systems, however, exhibit several drawbacks when applied to the preparation of a pliable multiple phase confectionery such as chewing gum in the form of a rolled tape. Variation in the rheological properties of the different components present the multiple phase confectionery product causes processing difficulties. It is problematic to form an integral multiple phase intermediary with the durability to withstand the stresses imposed by current processing equipment. In addition, the bleeding of colors across codispensed portions of the multiphase product detracts from consumer product appeal.

A need therefore exists for a confectionery dispensing apparatus capable of producing pliable multiple phase confectionery articles with sharp delineation between the phases. It is a further objective to produce a corresponding pliable multiple phase confectionery article in the form of a rolled tape.

### SUMMARY

The present disclosure is directed to a multiple phase confectionery article and an apparatus and method of producing the same. The confectionery article includes a substantially flat confectionery product that has a width and a thickness. The confectionery product is composed of at least two strands of confectionery material. Each strand of confectionery material extends across the width of the confectionery product. In addition, each strand extends through the thickness of the confectionery product. Each strand also has a visually different property. In an embodiment, each strand extends across the entire width of the confectionery product and also extends throughout the entire thickness of the confectionery product.

The number of visually different strands may be varied as desired. In an embodiment, the confectionery article includes from about 2 strands to about 10 strands, each strand having a visually different property. The visually different strands form a visual unit. Thus, a confectionery article with two visually different strands has a visual unit of two strands. Whereas a confectionery article with 10 visually different strands has a visual unit of 10 strands. In an embodiment, the confectionery article includes a repeating sequence of two visual units to about 50 visual units.

The visually different property of the strands may be based on color, the surface texture of each strand, or combinations thereof. The strand surface texture may be the result of the confectionery composition of the strand or a surface finish of the strand. The visually different property may be based distinctions between the same or different properties. In an embodiment, the visual distinction between the strands is based on strand color. In a further embodiment, a first strand may have a first color while a second strand may or may not have the same first color but may also have a surface texture that is visually different than the surface texture of the first strand. In yet a further embodiment, each visually different strand includes a corresponding organoleptic property different each other strand. The organoleptic property may include flavor, aroma, softness, mouthfeel, and combinations thereof.

The strands are in adherence with each other to form an integral multiple phase confectionery article. Accordingly, the strands may be coextruded strands, welded strands, cohered strands, compressively cohered strands, and combinations thereof. In an embodiment, the strands are made from confectionery material such as chewing gum, bubble gum, nougat, pliable confectionery material, taffy, chewy candy, caramel, and any combination thereof.

The width of the confectionery article may be defined by a leading edge and each strand may be substantially parallel to the leading edge. In an embodiment, the thickness of each strand substantially defines the thickness of the confectionery article. Consequently, each strand is visible from the top, bottom, and each side of the confectionery article. The thickness of the confectionery article may be from about 0.03 inches to about 2.0 inches. In an embodiment, the confectionery article may have a length from about 1 foot to about 15 feet and the length of each strand may be from about 3 inches to about one foot. The width of each strand may be from about 0.25 inches to about 12 inches.

In a further embodiment, the confectionery article is formed into the shape of a rolled tape. The rolled tape may be placed in a dispenser for convenient use by a consumer. In an embodiment, the confectionery article is a rolled tape having a repeating sequence of two strands each strand having a different color. In a further embodiment, the confectionery article is a rolled tape having a repeating sequence of three strands, each strand having a different color. Each strand may also have a different flavor. In yet a further embodiment, the two or three stranded rolled tape is chewing gum or bubble gum having a length of about 9 feet to about 15 feet with each strand having a length of about one foot.

In another embodiment, a confectionery article is provided having a substantially flat confectionery product having a thickness. The confectionery product includes at least two strands of a confectionery material extending through the thickness of the confectionery product. Each strand has a visually different property and the strands provide an undulating pattern in the confectionery product. The undulating pattern may be any aesthetically attractive pattern such as a swirl pattern, a random pattern, a twisted pattern, or a wavy pattern. Precise, definite delineation lines are present between the strands

In an embodiment, the confectionery article has a width and each strand extends across the width of the article. Each strand may be visible from the top, the bottom, and at least one side of the confectionery article. The confectionery material may be chewing gum, bubble gum, nougat, pliable confectionery material, taffy, chewy candy, caramel, and combinations thereof. In an embodiment, the confectionery article may be a rolled tape of chewing gum.

In a further embodiment, an apparatus for producing a multiple phase confectionery article is provided. The apparatus includes a manifold having a plurality of passageways, each passageway adapted to receive a respective plastic confectionery material. A dividing member is disposed adjacent the manifold for dividing each confectionery material into a plurality of plastic confectionery strands. The dividing member has a plurality dividing edges in conjunction with a plurality of channels to divide or otherwise split each plastic confectionery material into a plurality of plastic confectionery strands. Each channel of the dividing member is in fluid communication with a corresponding passageway for receiving a respective strand. An outlet member adjacent the dividing member has a plurality of orifices arranged in a linear orientation. Each orifice is in fluid communication with a corresponding channel to dispense the plurality of plastic strands from the outlet member. The plurality of plastic strands are codispensed from the outlet member and form a plastic confectionery slab comprising a substantially linear arrangement of the plastic strands in adherence to each other. In an embodiment, the outlet member may be a baffled outlet member for forming a plastic slab having a jointed side and a reciprocal jointed side.

In an embodiment, each plastic confectionery material has a visually different property and the plastic strand is correspondingly composed of strands having visually different properties. The visually different properties of the strands are the result of each plastic confectionery material having a visually different property. In a further embodiment, the channels in the dividing member are configured to align or otherwise position the strands having the same visual property in an alternating manner upon dispensing from the outlet member. This results in each strand in the slab adhering to a strand or strands having a different visual property.

The number of visually different plastic confectionery materials may range from two to about 10 or more different confectionery materials. It is understood that the manifold, dividing member, and outlet member may be configured with a respective number of passageways, channels and orifices in order to accommodate each confectionery material. Each plastic confectionery material may divided into two to about five plastic confectionery strands. The plastic slab typically entails from two to about 10 strands or more of visually distinct confectionery material.

The apparatus may include a conveyor for receiving the plastic slab and a cutting device for cutting the slab into a slab portion. In an embodiment, the apparatus includes a transfer device for moving a first slab portion into contact with a previously formed second slab portion. The transfer device moves a first side of the first slab portion into contact with a second side of a second slab portion to form a contact area. In a further embodiment, the apparatus includes a pressing device for pressing the first side onto the second side in the contact area. The first side adheres to the second side and forms an integral slab portion including first slab portion and second slab portion. The adherence between the sides is strong enough to maintain the integral slab portion intact during subsequent processing steps such as sheeting, curing, and scoring, for example.

The present disclosure further provides for an apparatus for producing a confectionery product from a first confectionery slab portion having a first side and a second confectionery slab portion having a second side. The apparatus includes a transfer device for moving the first side into contact with the second side to form a contact area and a pressing device applying pressing force onto the contact area. The pressing device applies a downward force or pressure that causes the first side of the first slab portion to adhere to the second side of the second slab portion thereby forming an integral slab portion comprising the first and second slab portions. In an embodiment, the integral slab remains intact as a unitary substrate during subsequent processing procedures.

A further apparatus for producing a confectionery product is provided in the present disclosure. The apparatus includes a confectionery dispensing device having a baffled outlet member for forming a first confectionery joint slab and a second confectionery joint slab. Each confectionery joint slab has a jointed side and a reciprocal jointed side. A transfer device moves the first confectionery joint slab so that the jointed side of the first confectionery joint slab comes into contact with the reciprocal jointed side of the second confectionery joint slab. The apparatus may include a pressing device for pressing the jointed side onto the reciprocal jointed side. The jointed side and the reciprocal jointed side are in adherence with each other to form an integral slab portion comprising the first and second jointed slab portions. The jointed side and the reciprocal joint side advantageously form a step joint which promotes improved adherence between the slabs ensuring that the integral slab portion remains intact during following processing procedures.

A further apparatus for producing a multiple phase confectionery article is provided in the disclosure. The apparatus includes a manifold that has a plurality of passageways. Each passageway is adapted to receive a respective plastic confectionery material. Each passageway also has an outlet on an outlet surface of the manifold. A dispensing member having an opening is disposed adjacent the manifold and is in movable engagement with the outlet surface. The movable dispensing member places the opening in fluid communication with each passageway outlet to sequentially dispense an amount of each plastic confectionery material from the manifold to form a continuous confectionery article with sequential segments of each confectionery material. The passageway outlets are adjacent each other on the manifold outlet surface and, in an embodiment, the passageway outlets are in a vertical arrangement on the manifold outlet surface. In an embodiment, each plastic confectionery material has a different visual property resulting in a continuous confectionery article having a repeating sequence of the visually different properties.

A drive mechanism may be placed in operative communication with the dispensing member to move or otherwise slide the dispensing member along the manifold outer surface. The dispensing member is configured to block any passageway outlet that is not in fluid communication with the opening. Consequently, the apparatus dispenses an amount of a single plastic confectionery material at any given instant.

In an embodiment, the dispensing member has a plurality of ports. Each port is associated with a corresponding passageway outlet and a corresponding confectionery material. Each port is configured to come into fluid communication with its respective passageway outlet when the outlet is blocked by the dispensing member. In other words, when an outlet is not in fluid communication with the dispensing member opening, the outlet is placed in fluid communication with its corresponding port. In an embodiment, the port places the passageway outlet in fluid communication with the respective source of the plastic confectionery material. The ports advantageously permit the recycle of non-dispensed confectionery material. In addition, the ports maintain each plastic confectionery material in a flowing state which maintains flow consistency of the confectionery material and reduces or substantially eliminates flow lag time when the dispensing member opening is placed in fluid contact with the outlet.

In an embodiment, the apparatus includes a conveyor for receiving the continuous confectionery article. A controller may be placed in operative communication with the conveyor and the dispensing member. The controller may then be used to coordinate the movement of the dispensing member opening between the outlets and the movement of the conveyor. In an embodiment, the controller coordinates or otherwise directs the conveyor to move when the opening is in fluid communication with an outlet. Alternatively, the controller may direct the conveyor to stop moving when the opening is not in fluid communication with an outlet. Coordination between the dispensing member and the conveyor advantageously ensures the formation of a continuous multiphase confectionery article having substantially no inconsistencies along the body of the article.

The present disclosure also includes a method for making a confectionery article. The method includes providing a first plastic slab of a confectionery material and a second plastic slab of a confectionery material. Each slab has respective opposing sides. The method entails contacting a side of the first slab with a side of the second slab and pressing the contacting sides together to produce a substantially flat confectionery product. The contacting may entail overlapping a side of the first slab with the side of the second slab. This forms an overlap portion. The overlap portion may be flattened to form the substantially flat confectionery product. In an embodiment, the pressing promotes the first side to adhere to the second side to form an integral plastic slab that includes the first and second plastic slabs. The pressing may also include additional sheeting steps or procedures to flatten the confectionery product to a particular thickness as desired. The adherence between the first and second sides is sufficient to maintain the integral slab as a unitary piece during further processing procedures.

In an embodiment, the first plastic slab includes a strand of confectionery material extending along each of the opposing sides of the plastic slab. Each strand each has a visually different property. The second plastic slab may also include a strand of confectionery material extending along each opposing side, whereby the strands of the second plastic slab each have a visually different property. The method may include contacting a strand of the first plastic slab with a strand of the second plastic slab. In a further embodiment, a strand in each of the first and second slabs has or otherwise shares the same visual property. The method may include contacting the first and second slabs along the strand with this common visual property.

In a further embodiment, the first slab has a joint side and the second slab has a reciprocal joint side and the method includes contacting or otherwise engaging the joint side with the reciprocal joint side to form a step joint between the first and second slabs. The joint may then be flattened to form the substantially flat confectionery article.

In another embodiment, the method may include forming the confectionery product into a rolled tape. This may be accomplished by rolling the substantially flat confectionery product about an outermost confectionery product edge (i.e., such as a leading edge of the confectionery product) and subsequently cutting the confectionery product perpendicular to the edges to a desired width to form the rolled tape of confectionery product. The rolled confectionery tape may be placed in a dispenser. A consumer may then dispense the confectionery tape from the dispenser by grasping an edge of the tape and pulling a desired length of the tape from the dispenser. The consumer may then tear the length of tape off the rolled tape to enjoy the confectionery product.

In a further embodiment, the method of making a confectionery article includes providing a first plastic slab of a confectionery material and a second plastic slab of a confectionery material, each slab having opposing sides as previously discussed. The first plastic slab is at located at a first location and the second plastic slab is located at a second location. The method entails moving the first plastic slab from the first location to the second location and contacting a side of the first slab with a side of the second slab. The contacting sides may be pressed together to produce a substantially flat confectionery product. The pressing may be sufficient to adhere the first slab to the second slab to from an integral slab. In an embodiment, the moving may include lifting the first plastic slab with the transfer device from the first location, transporting with the transfer device the first plastic slab from the first location proximate to the second location. The first slab may then be lowered by the transfer device onto the second location thereby contacting a side of the first slab with a side of the second slab.

The present invention provides a further method of making a confectionery article. The method includes providing a manifold containing a plurality of passageways. Each passageway is adapted to receive a respective plastic confectionery material. Each passageway has an outlet on an outlet surface of the manifold. A dispensing member having an opening is in operative communication with, and movably engaged with the manifold outlet surface. The method includes sequentially dispensing an amount of each confectionery material by sequentially placing the opening in fluid communication with each outlet, and forming a continuous confectionery article having an amount of each confectionery material in a sequential order. The formed continuous confectionery article consequently has a repeating sequence of each confectionery material. In an embodiment, each plastic confectionery material has a visually different property. The dispensing member is configured to block any outlets not in fluid communication with the opening. In a further embodiment, the method includes rapidly sliding the dispensing member along the manifold outlet surface to sequentially place the opening in fluid communication with each outlet.

In an embodiment, the dispensing member includes a plurality of ports, each port associated with and corresponding to a respective outlet. The method includes placing a respective port in fluid communication with a corresponding blocked outlet. Each port is in fluid communication with a respective source of plastic confectionery material. Thus, placing the port in fluid communication with its respective outlet places the outlet in fluid communication with the source of confectionery material.

In an embodiment, a conveyor receives the continuous confectionery article and moves it away from the manifold. The moving of conveyor may be coordinated with the sequential dispensing of the confectionery materials. For example, the movement of the conveyor may be halted when the opening is not in fluid communication with an outlet.

In a further embodiment, the manifold contains first and second passageways with respective first and second outlets receiving respective first and second plastic confectionery materials. The first outlet is located at a first position on the manifold outlet surface and the second outlet located at a second position on the manifold outlet surface. The method includes moving the opening between the first and second positions to sequentially dispense amounts of the first and second confectionery materials. The moving may be the result of rapidly sliding the dispensing member along the manifold outlet surface. The time duration of the movement of the opening between the first and second positions may be from about 0.03 seconds to about 0.5 seconds. The first and second confectionery materials may each have a visually different property so that the continuous confectionery article has a repeating sequence of amounts of the first and second confectionery materials.

The present disclosure provides an alternate method of making a multiple phase confectionery article. The method includes providing a confectionery product having at least two strands of a confectionery material. Each strand has a visually different property. The method entails twisting the confectionary product about a longitudinal axis thereof to form a twisted confectionery product. The twisted confectionery product is then pressed to form a substantially flat confectionery article having an undulating pattern. In an embodiment, the method may include coextruding the at least two strands. The undulating pattern may be any attractive pattern such as a swirl pattern, a random pattern, a twisted pattern, or a wavy pattern.

Additional features and advantages of the present invention are described in, and will be apparent from, the following Detailed Description of the Invention and the figures.

### BRIEF DESCRIPTION OF THE FIGURES

FIG. 1 is a perspective view of a confectionery depositing apparatus in accordance with the present invention.

FIG. 2 is a perspective view of a manifold assembly and a transfer device of FIG. 1.

FIG. 3 is an exploded perspective view of the manifold assembly of FIG. 2.

FIG. 4 is a perspective view of the inlet side of the manifold of FIG. 3.

FIG. 5 is a perspective view of the outlet side of the manifold of FIG. 4.

FIG. 6 is a perspective view of the inlet side of a dividing member of FIG. 3.

FIG. 7 is a perspective view of the outlet side of the dividing member of FIG. 6.

FIG. 8 is a perspective view of the inlet side of an outlet member of FIG. 3.

FIG. 9 is a perspective view of the outlet side of the outlet member of FIG. 8.

FIG. 10 is a perspective view of a baffled outlet member in accordance with an alternate embodiment.

FIG. 11 is a perspective view of the manifold assembly and the transfer device in accordance with an embodiment of the present invention.

FIG. 12A is a perspective view of the formation of a jointed slab portion in accordance with an embodiment of the present invention.

FIG. 12 B is an enlarged fragmentary view of the jointed slab portion of FIG. 12A.

FIG. 13A is a perspective view of the completed jointed slab portion of FIG. 12A.

FIG. 13B is an enlarged fragmentary view of the completed jointed slab portion of FIG. 13A.

FIG. 14A is a perspective view of the formation of a slab contact area in accordance with an alternate embodiment of the invention.

FIG. 14B is an enlarged fragmentary view of the slab contact area of FIG. 14A.

FIG. 15A is a perspective view of the completed slab contact area of FIG. 14A.

FIG. 15B is an enlarged fragmentary view of the slab contact area of FIG. 15A.

FIG. 16 is a perspective view of a sheeting process in accordance with an embodiment of the present invention.

FIG. 17 is a perspective view of a rolled sheet of confectionery material in accordance with an embodiment of the present invention.

FIG. 18 is an exploded perspective view of a rolled tape of confectionery material and a dispenser in accordance with an embodiment of the present invention.

FIG. 19 is a perspective view of a rolled tape of confectionery product dispensed from a dispenser in accordance with an embodiment of the present invention.

FIG. 19A is an enlarged fragmentary left elevational view of the confectionery product of FIG. 19.

FIG. 20 is a perspective view of a confectionery depositing apparatus in accordance with an alternate embodiment of the present invention.

FIG. 21 is an enlarged fragmentary view of the confectionery depositing apparatus of FIG. 20.

FIG. 22 is a left elevation view of the confectionery depositing apparatus of FIG. 20 in a first dispensing position.

FIG. 23 is a left elevation view of the confectionery depositing apparatus of FIG. 20 in a second dispensing position.

FIG. 24 is a perspective view of a confectionery depositing apparatus in accordance with an alternate embodiment of the present invention.

FIG. 25 is a fragmentary perspective view of the confectionery depositing apparatus of FIG. 24.

FIG. 26 is a fragmentary perspective view of the confectionery depositing apparatus of FIG. 24.

FIG. 27 is a confectionery product in accordance with an alternate embodiment of the present invention.

FIG. 28 is a front elevation view of the confectionery product of FIG. 27.

### DETAILED DESCRIPTION

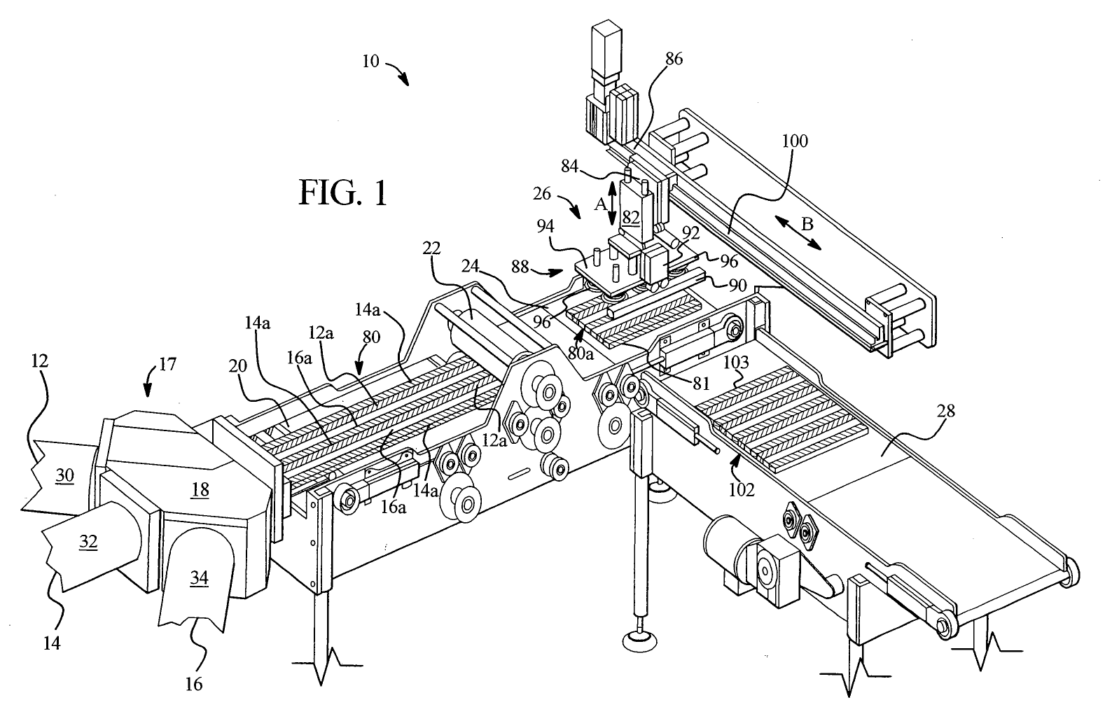

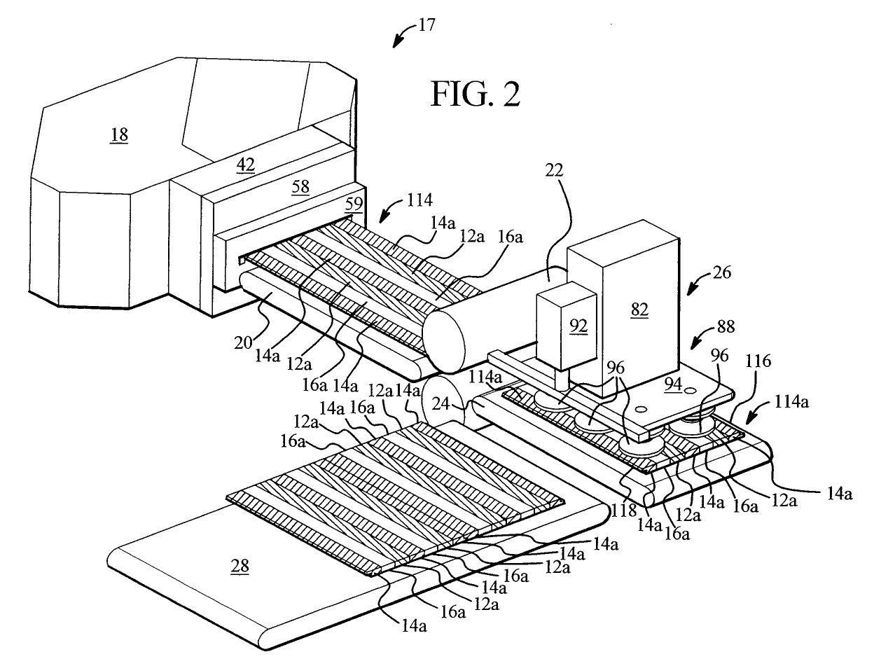

Referring to the Figures generally, where like reference numerals denote like structure and elements, and in particular to FIGS. 1-2, a confectionery depositing apparatus 10 for producing a multiple component confectionery article is shown. Apparatus 10 includes sources of plastic confectionery material 12, 14, 16, manifold assembly 17, conveyors 20 and 24, a cutting device 22 therebetween, transfer device 26, and conveyor 28. Although FIG. 1 shows three confectionery sources, apparatus 10 may include as few as a single confectionery source to as many as 2, 3, 4, 5, or 10 or more sources of confectionery material. In an embodiment, each confectionery source may include heating elements (not shown) to maintain the confectionery material in a flowable state. The confectionery materials may be the same or different. Accordingly, sources of confectionery material 12, 14, 16 may be adapted to maintain each confectionery material at the same or at different temperatures. Nonlimiting examples of confectionery sources include extruders and hoppers as are commonly known in the art.

Confectionery materials 12, 14, and 16 may include any confectionery material that flows, is flowable, may placed into a flowable state, or otherwise provides a plastic confectionery material. Nonlimiting examples of flowable or plastic confectionery material includes syrups, liquids, gels, pastes, colloids, or solids for making hard candies, soft candies, lollipops, fondants, toffees, jellies, chewing gums, bubble gums, chocolates, gelatins, caramel, taffy and nougats. The confectionery material may include sugar or may be sugar-free. The confectionery material may further include a pharmaceutical product or a medicament.

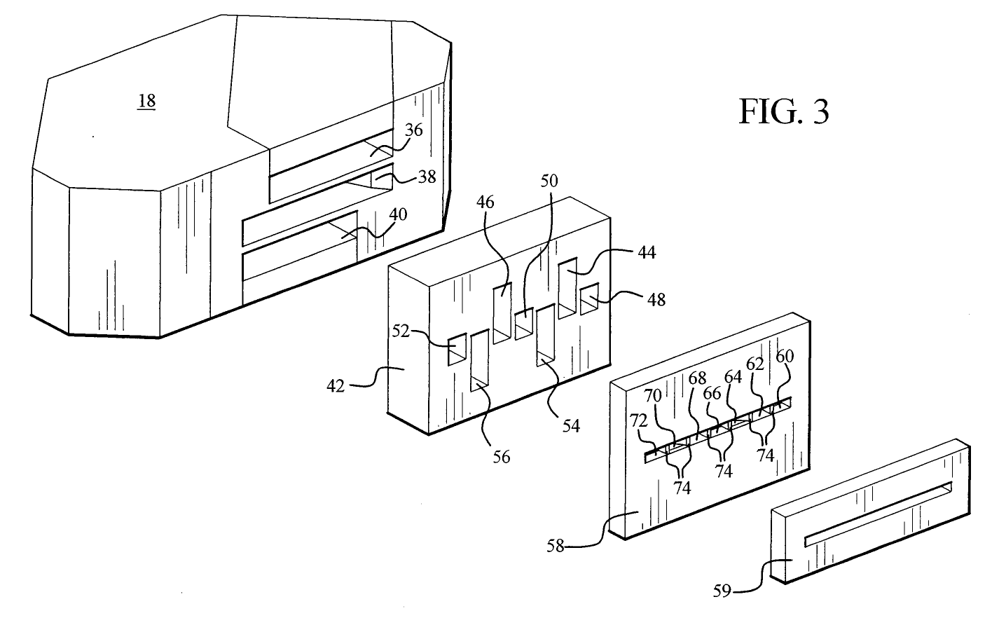

Conduits 30, 32, and 34 place confectionery sources 12, 14, 16 respectively in fluid communication with manifold assembly 17. The exploded view provided by FIG. 3 shows the components of manifold assembly 17, namely a manifold 18, a dividing member 42, an outlet member 58, and a housing 59. Manifold 18 has passageways 36, 38, and 40, each passageway adapted to receive a respective flow of confectionery material as shown in FIGS. 3-5. For example, confectionery material from source 12 (hereinafter plastic confectionery material 12a) may flow into passageway 36, confectionery material from source 14 (hereinafter plastic confectionery material 14a) may flow into passageway 38 and confectionery material from source 16 (hereinafter plastic confectionery material 16a) may flow into passageway 40. It is understood that the number of passageways provided in manifold 18 may be varied as necessary to accommodate varying numbers of sources of plastic confectionery material as desired.

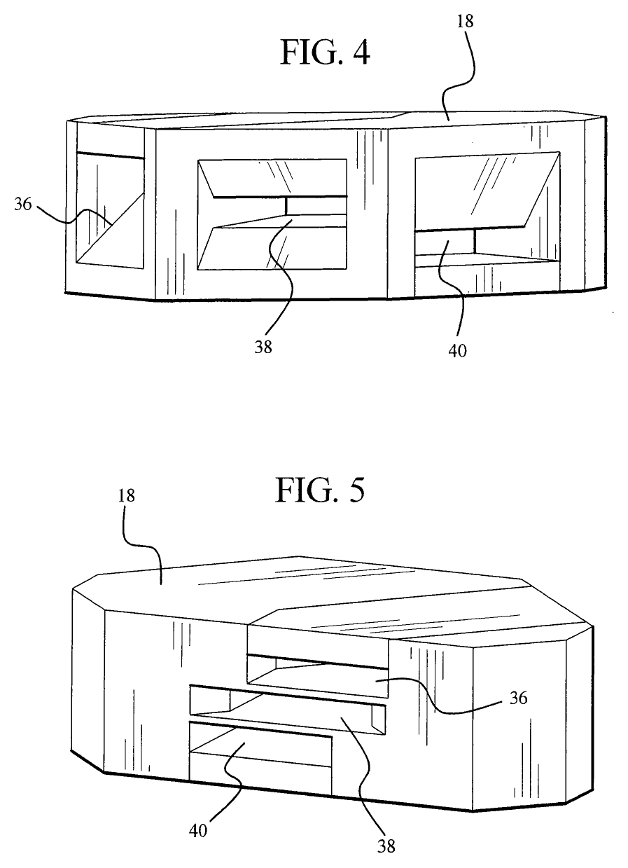

Each passageway has a wide inlet end for receiving the plastic confectionery, the passageway narrowing as the passageway extends to the outlet end as shown in FIGS. 4 and 5. Passageways 36, 38, and 40 are formed so that the passageway outlets are in close proximity to each other as shown in FIG. 5.

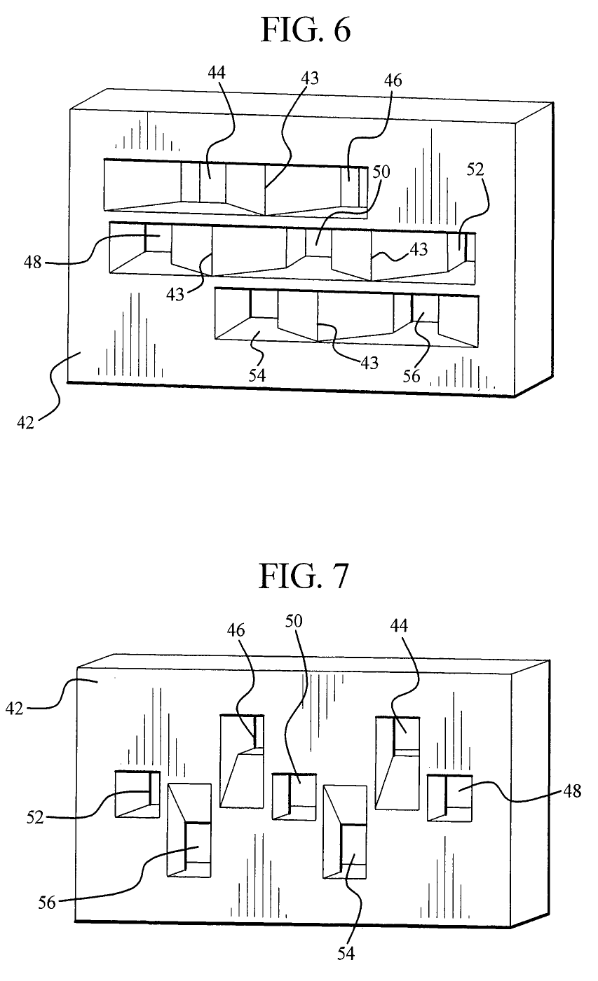

Adjacent the outlet end of manifold 18 is dividing member 42 having channels 44, 46, 48, 50, 52, 54, and 56 as shown in FIGS. 3, 6 and 7. As shown in FIG. 6, the inlet side of dividing member 42 has dividing edges 43 that divide the flow of plastic confectionery materials 12a, 14a and 16a into confectionery strands. The channels are positioned to operate in conjunction with the dividing edges. The channels are in fluid communication with the manifold passageways, each channel receiving a respective strand that has been divided by the dividing members. In particular, channels 44 and 46 are in fluid communication with passageway 36 thereby dividing confectionery material 12a into two plastic strands; channels 48, 50, and 52 are in fluid communication with passageway 38 and divide or otherwise split plastic confectionery material 14a into three individual plastic strands; and channels 54 and 56 are in fluid communication with passageway 40 and split plastic confectionery 16a into two individual plastic strands. The skilled artisan will appreciate that each plastic confectionery material emanating from the manifold passageways may be split into any number of individual plastic strands as desired. In an embodiment, each plastic confectionery material flowing from the manifold passageways is divided into two to five or more individual strands. The division into individual strands need not be uniform. Indeed, while one or more confectionery materials may be split into two or more individual strands, one or more other confectionery materials may not be split at all. In an embodiment, two plastic confectionery materials are split into two strands while the third confectionery material flowing from the manifold is divided into three individual strands as shown in FIGS. 6 and 7. Thus, the number of ways in which to split/not split multiple confectionery flows entering the dividing member is essentially limitless.

As can be seen in FIGS. 6 and 7, the diameter or width of each channel is larger on the inlet side (FIG. 6) of dividing member 42 than on the outlet side (FIG. 7). The larger channel diameter on the inlet side advantageously ensures leak-free fluid communication between manifold 18 and dividing member 42. Dividing member 42 is configured so that the outlets of each channel are oriented in a linear or substantially linear arrangement ensuring proper channel alignment and leak-free fluid communication with outlet member 58.

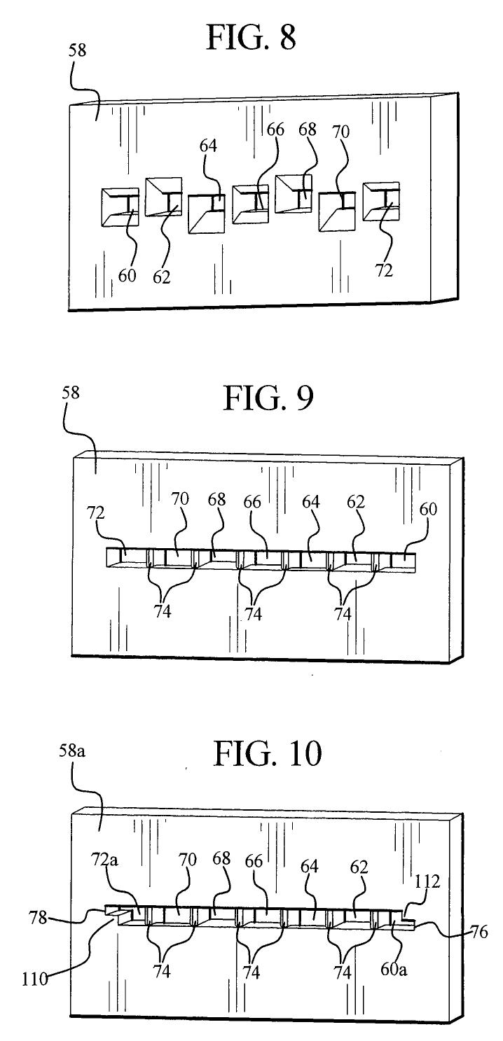

Outlet member 58 is disposed adjacent to dividing member 42 as shown in FIG. 3. The inlet side of outlet member 58 is adjacent to the outlet side of dividing member 42. As shown in FIGS. 3, 8 and 9, outlet member 58 has a plurality of orifices 60, 62, 64, 66, 68, 70, and 72 that are in fluid communication with a corresponding channel of dividing member 42. Accordingly, each orifice is adapted to receive an individual plastic strand from the dividing member and dispense the strands in an ordered, predetermined arrangement. In an embodiment, fluid communication exists between the following channel-orifice pairs: channel 52 and orifice 72, channel 56 and orifice 70, channel 46 and orifice 68, channel 50 and orifice 66, channel 54 and orifice 64, channel 44 and orifice 62 and channel 48 and orifice 60. The width or diameter of the orifices are wider on the inlet side of outlet member 58 (FIG. 8) than on the outlet side of the outlet member 58 (FIG. 9) to accommodate the outlet diameter of the dividing member channels. The orifices are disposed in outlet member 58 in a substantially linear orientation with spacers 74 separating each orifice.

In an embodiment, baffle outlet member 58a includes end orifices, namely 60a and 72a, having jointed edges as shown in FIG. 10. In particular, orifice 60 may be formed with jointed edge 76 and orifice 72a may be configured with reciprocal jointed edge 78. Jointed edge 76 and reciprocal jointed edge 78 may be used to advantageously form a plastic confectionery product with jointed sides as will be discussed in detail below.

The confectionery materials 12a, 14a, and 16a may progress through the manifold, dividing member, and the outlet member by way of a drive or flow system as is commonly known in the art with a screw extruder, hydraulic, pneumatic or pressurized drive systems as nonlimiting examples. The drive system pushes plastic confectionery materials 12a, 14a, and 16a through manifold 18, through dividing member 42 which separates each confectionery material into a respective series or plurality of individual strands, the strands being arranged in a substantially linear orientation by way of the channels and orifices. The individual strands are subsequently simultaneously codispensed through outlet member 58. As shown in FIG. 1, this produces slab 80 composed of individual strands of plastic confectionery materials 12a, 14a, and 16a in a substantially linear arrangement with the strands in coherence with each other. The strands may be coextruded strands, welded strands, cohered strands, or compressively cohered strands.

In an embodiment, each plastic confectionery material 12a, 14a, and 16a has a visually different property. In other words, each plastic confectionery material is visually distinct or has a different visual property with respect to each other confectionery material. Nonlimiting examples of properties, characteristics, or qualities that may be utilized to yield, denote, or indicate a visual or otherwise an observable distinction in each plastic confectionery strand include hue, color, texture, surface roughness, surface finish, surface embossment, confectionery material composition and combinations thereof. Thus, confectionery materials that may be formed or otherwise processed to yield one, some, or all of these properties or characteristics are within the scope of this disclosure. For example, confectionery material 12a may have a smooth or shiny surface texture, confectionery material 14a may have a rough surface and confectionery material 16a may have an excessively rough or aerated or otherwise pocketed surface. Alternatively, the visual distinction or difference between each confectionery material need not be based on variations of the same property. Consequently, confectionery material 12a may be blue in color, while confectionery material 14a may have a rough texture (and may or may not be blue in color), and confectionery material 16a may be transparent or translucent and have a shiny or glossy surface finish (and may or may not be blue in color). In an embodiment, the ingredients of the confectionery materials may yield visually different properties. For example, one confectionery material may include small particulates dispersed therein to produce confectionery strands having a grainy or granular surface texture. Another confectionery material may be a nougat type confectionery with a course surface and/or texture. Yet another confectionery material may be a flexible candy with a smooth surface or a shiny or a glassy or translucent appearance.

In a further embodiment, the surfaces of one, some, or all of the orifices may be configured to provided with various protrusions, teeth, depressions and/or indentations to apply a distinct surface texture to the individual strands during dispensing from the outlet. This may produce strands having striations or other surface textures. In an embodiment, each confectionery material has a different color. For example, confectionery material 12a may be red, confectionery material 14a may be green and confectionery material 16a may be yellow. Thus, the individual strands have the same color of the corresponding confectionery material from which each series of strands are made. The dispensed plurality of strands form slab 80 of multiple colors as shown in FIG. 1.

In an embodiment, the channels of the dividing member are configured to arrange strands of the same confectionery material in an alternating manner. This produces a plastic slab whereby strands of the same color (or identical or common visual properties) do not contact each other. In a further embodiment, the channels of the dividing member are configured to arrange or otherwise position the colored strands in a predetermined arrangement or order such as a repeating sequence. This yields a dispensed plastic slab having a plurality of individual strands disposed in a predetermined order that provide a repeating sequence of visual properties. This repeating sequence can be seen in FIGS. 1, 2, and 11-16 whereby the plastic slab includes individual strands 14a of confectionery material 14, strands 16a of confectionery material 16, and strands 12a of confectionery material 12. The dividing member and the outlet member are configured to dispense the strands in the following sequence or arrangement: 14a, 16a, 12a, 14a, 16a, 12a, 14a, etc. In an embodiment, strands 14a may be green, strands 16a may be yellow, and strands 12a may be red. This produces a plastic slab having a visually repeating sequence of green-yellow-red-green-yellow-red. It is understood that the color order, the number of colors and the particular color type may be varied as desired.

In an embodiment, each visually different strand may further entail a different organoleptic property. Each confectionery material 12, 14, and 16 may have a different flavor, aroma, softness, mouthfeel, and combinations thereof as desired. For example confectionery material 12 may have a rough surface texture and a sweet flavor, confectionery material 14 may be translucent or transparent and have a sour flavor, and confectionery material 16 may have a granular surface texture and a nutty flavor. In an embodiment, slab 80 may have strands 16a which may be yellow and may further include a first flavor, such as a lemon flavor, strands 14a may be green and may have a second flavor, such as lime flavor, and strands 12a which may be red and may have a third flavor such as a cherry flavor. The skilled artisan will appreciate that the permutations between differing visual properties and differing organoleptic properties may be virtually limitless.

Returning to FIG. 1, apparatus 10 includes conveyor 20 which moves slab 80 to cutting device 22. Cutting device 22 cuts slab 80 into a slab portion 80a which is moved onto conveyor 24. Transfer device 26 subsequently moves slab portion 80a from conveyor 24 to conveyor 28. Transfer device 26 includes a base 82 which supports a vertical lift member 84, a drive member 86, a contact member 88, a pressing device 90 and a corresponding actuator 92. Vertical lift member 84 provides up and down movement to transfer device 26 (as indicated by double-headed vertical arrow A in FIG. 1) to move contact member 88 towards and away from the top surface of slab portion 80a. Vertical lift member 84 may be any mechanical, electrical, hydraulic, pneumatic device or mechanism that provides up and down or otherwise vertical movement as is commonly known in the art.

Contact member 88 includes a platform 94 that supports a plurality of cups 96, each cup in operative communication with a pressure system (not shown). Cups 96 may be made of a flexible, resilient material that does not adversely impact or distort slab 80a upon contact therewith. Nonlimiting examples of suitable materials for cups 96 include synthetic and natural rubbers, elastomers and thermoplastic elastomers. In an embodiment, cups 96 are made of a silicone-based material. It has been found that silicone-based materials alleviate sticking problems between the cup edges and the slab portion.

In an embodiment, the pressure system may be a vacuum system or the like which provides negative pressure to each cup interior. Upon contact between the cup edges and slab portion 80a, the negative pressure within the cup interior provides a suction force to draw portions of the top surface of slab 80a into firm contact with cups 96. This enables contact member 88 to lift slab portion 80a off of conveyor 24 when vertical lift member 84 moves transfer device 26 upward. FIG. 2 shows cups 96 in contact with the top surface a slab portion just prior to lifting the slab portion off of conveyor 24. It is understood that transfer device 26 may be equipped with sensors to determine whether contact between the cups and the slab portion has occurred and/or to detect the suction force present in each cup interior.

Apparatus 10 further includes horizontal guide 100 in operative communication with drive member 86. Drive member 86 includes a drive mechanism in cooperation with horizontal guide 100 that moves transfer device 26 in a back and forth or otherwise horizontal manner as shown by double-headed arrow B in FIG. 1. The drive mechanism may be any electrical, mechanical, hydraulic or pneumatic device that may engage horizontal guide 100 to move transfer device 26 about or otherwise along the guide as is commonly known in the art.

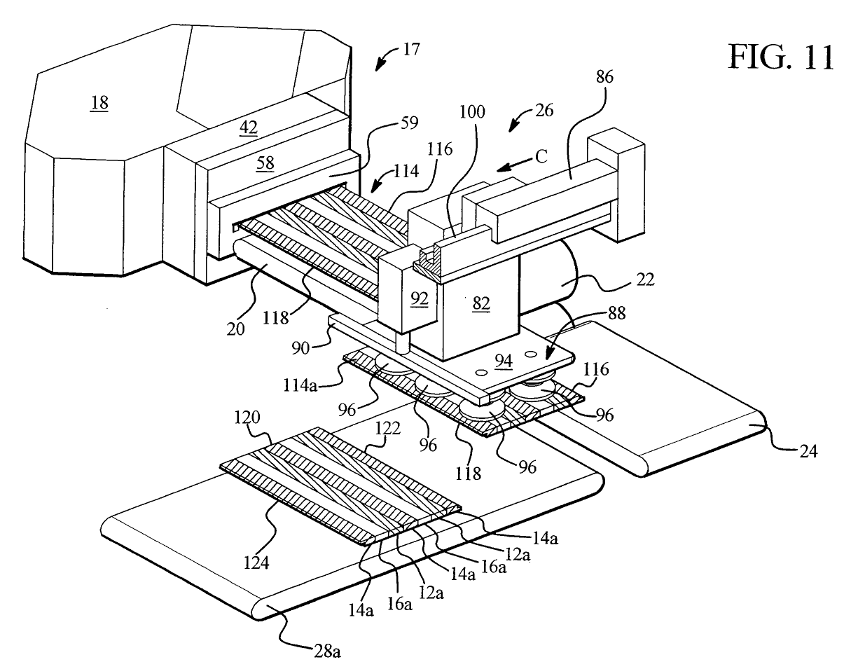

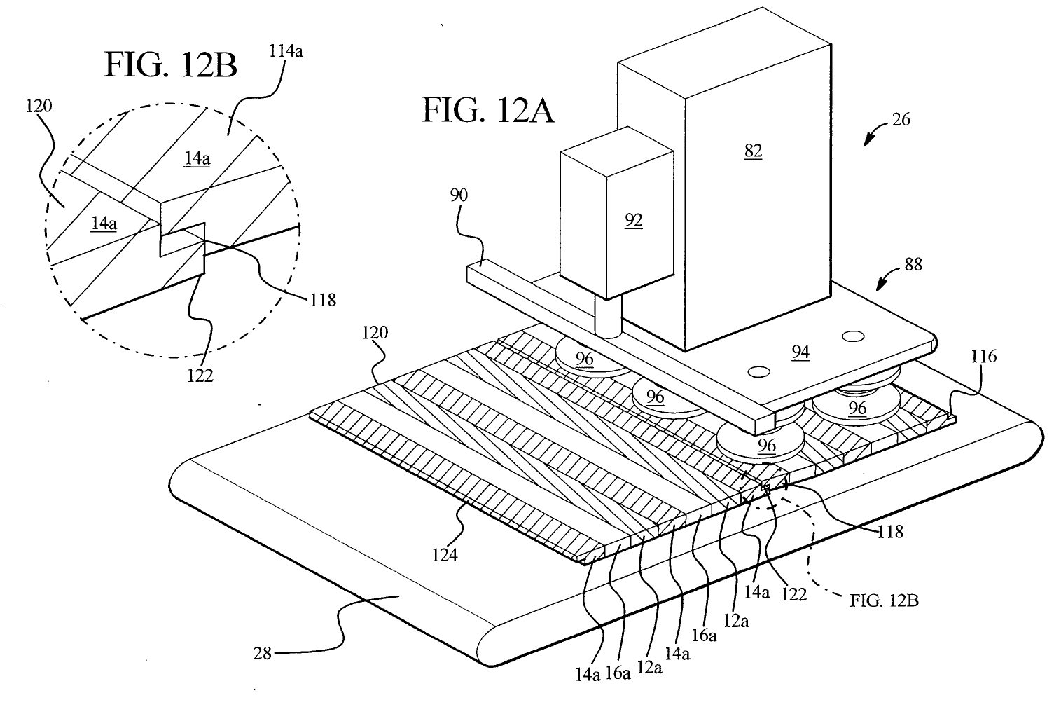

Once transfer device 26 has raised a slab portion of off conveyor 24, drive member 86 moves transfer device 26 along horizontal guide 100 to place the slab portion above conveyor 28. FIG. 11 shows transfer device 26 holding a slab portion in a raised or elevated position while moving the slab portion from a first location above conveyor 28 as indicated by direction arrow C. Vertical lift member 84 then operates to move contact member 88 downward lowering the slab portion onto a second location, namely the surface of conveyor 28 as shown in FIGS. 12A, 13A, 14A, and 15A. The pressure system may then be disengaged to terminate the negative force/pressure within cups 96. Upward movement of contact member 88 by way of vertical lift member 84 in conjunction with the mass of the slab portion disengages contact between cups 96 and the top surface of the slab portion. In an embodiment, the pressure system may provide a positive pressure in the cup interiors to promote or otherwise hasten disconnection between cups 96 and slab 80a.

In an embodiment, a second slab portion is present on conveyor 28 when transfer device 26 delivers the first slab portion to conveyor 28 as shown in FIGS. 1,2 and 11-15B. The second slab portion may be made from one, two, three to as many as five, 10 or more individual slab portions as previously discussed. FIG. 1 shows second slab portion 102 made from two individual slabs. Transfer device 26 moves slab 80a off of the surface of conveyor 24 and above conveyor 28 so that side 81 of slab 80a contacts a side 103 of second slab portion 102 when vertical lift member 84 lowers slab 80a onto conveyor 28. It is understood that apparatus 10 may include sensors to assist in the proper placement of transfer device 26 along horizontal guide 100 in order to ensure contact between slab 80a and slab 102.

The contacting sides 81 and 103 of slabs 80a and 102 respectively form a contact area between the two slabs. In an embodiment, actuator 92 provides up and down movement of pressing device 90 and moves pressing device 90 into contact with contact area 104. Once in contact with contact area 104, pressing device 90 may be moved in a further downward direction to ensure cohesive contact or adherence between side 81 of first slab portion 80a and side 103 of second slab portion 102. Pressing device 90 has a substantially flat lower surface that provides a downward force that compressively coheres side 81 to side 103. Application of pressing device ensures that slab portion 80a and slab portion 102 are suitably adhered to each other thereby forming a single integral slab. In an embodiment, the force imparted by pressing device 90 onto contact area 104 is sufficient to form a unitary slab that remains an integral slab component throughout the remaining processing stages. Once cohesion between the two slab portions is accomplished, actuator 92 then moves pressing device 90 upward and away from contact area 104. In an embodiment, pressing device 90 is made from a material that exhibits little or no adhesion with the slabs when in contact therewith. A nonlimiting example of a suitable material for pressing device 90 is TEFLON® or the like.

The pressure system may or may not be activated during the slab cohesion process. Accordingly, cups 96 may or may not be in contact with the transferred slab portion during the cohesion process. It is thereby understood that movement of the pressing device may occur simultaneously with, may be coordinated with, or may occur independently of the release of the transferred slab portion from transfer device 26. The integral slab thereby proceeds along conveyor 28 to further sheeting, rolling, curing, scoring and packaging processing stages as are commonly known in the art.

In an embodiment, baffles 110 and 112 disposed in outermost orifices 72a and 60a of baffled outlet member 58a form respective edges 78 and 76 of orifice 72a and 60a as shown in FIG. 10. Orifices 72a and 60a consequently dispense outer strands having a joint as a result of respective edges 78 and 76 to form slab 114 having jointed sides 116 and 118 as shown in FIGS. 2 and 11-13B. In an embodiment, baffles 110 and 112 are positioned in a reciprocating arrangement in the respective orifices. As shown in FIG. 2, cutting device 22 may be used to cut jointed slab 114 into jointed slab portion 114a as previously discussed.

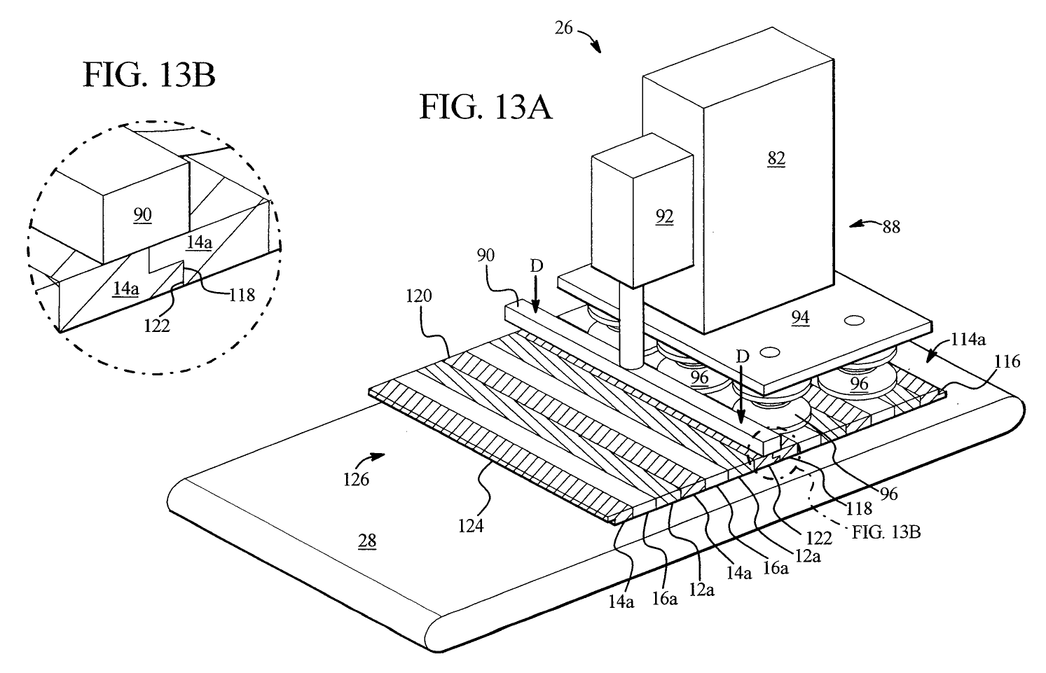

In an embodiment, transfer device 26 delivers jointed slab portion 114a from conveyor 24 into contact with a jointed slab portion 120 located on conveyor 28 as shown in FIGS. 2, and 11-13B. Jointed slab portion 120 has jointed sides 122 and 124. Apparatus 10 may include sensors proximate to conveyor 28 and in operative communication with transfer device 26 to assist in aligning the jointed side 118 of slabs 114a and jointed side 122 of slab portion 120 as the sides of slabs 114a and 120 come into contact with each other. Vertical lift member 84 lowers contact member 88 to cooperatively contact jointed side 118 of slab portion 114a with jointed side 122 of slab portion 120. FIGS. 12A-13B illustrate the reciprocal engagement between jointed side 118 and jointed side 122 that forms a slab contact area that is a step joint between the slabs. Indeed, joint 118 may be considered a reciprocal jointed side that cooperatively engages and joins jointed side 122. Actuator 92 may then be used to drive pressing device 90 downward (as indicated by downward arrows D in FIG. 13A) to press and provide cohesive adherence between slab portions 114a and 120 vis-à-vis jointed sides 118 and 122 as shown in FIGS. 13A and 13B. The step joint configuration for forming slab portions 114a and 120 into an integral slab 126 is advantageous as it provides more surface area contact between the adjoining slab sides and further provides a cohesive connection between the slabs wherein the contact area formed by the jointed sides has substantially the same height after the pressing step as the other portions of the slabs. Integral slab 126 may then be moved along conveyor 28 for further pressing and sheeting with conventional sheeting and rolling equipment to produce a substantially flat sheet of confectionery material. In an embodiment the pressing force is sufficient to ensure that integral slab 126 remains intact as a single piece throughout all subsequent processing stages. The step joint arrangement also advantageously provides a seamless weld between the two slabs. Accordingly, upon further sheeting no seam or evidence of a joint is observable in the finished confectionery article. This is particularly evident when the step joint occurs with two strands having the same visual property.

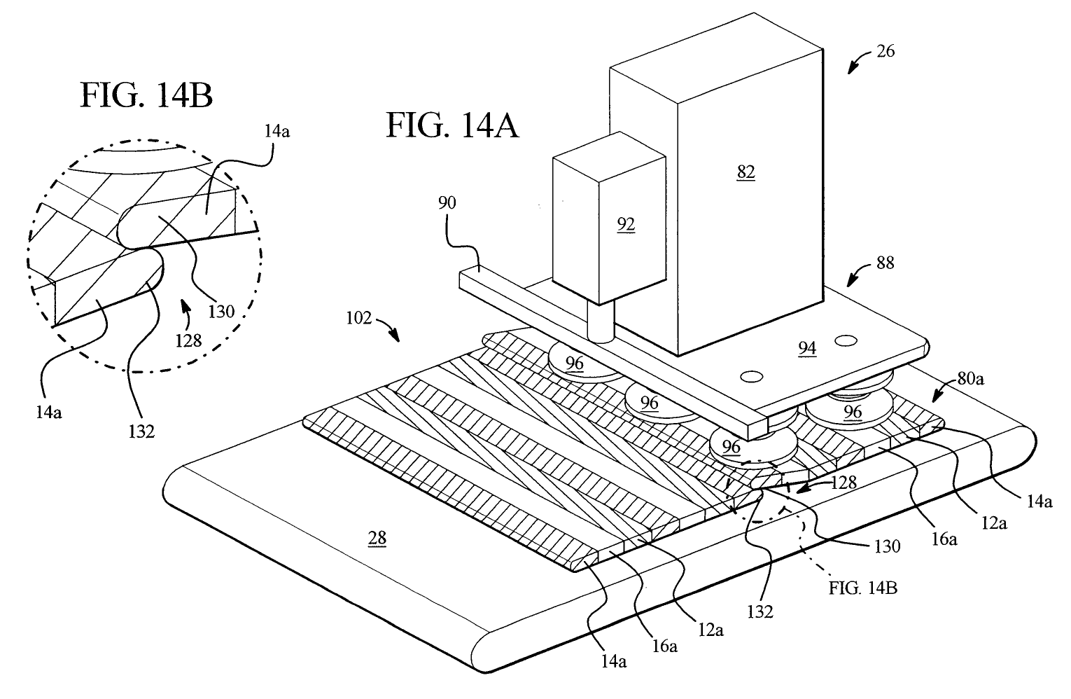

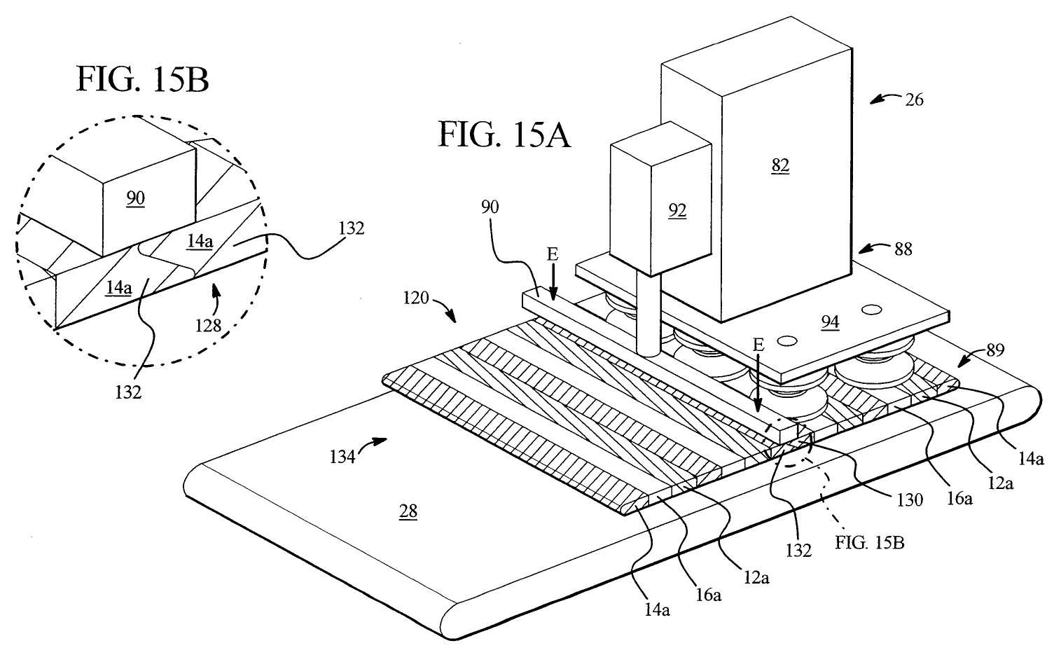

In an embodiment, transfer device 26 may be used to move slab portion 80a off of conveyor 24 and onto conveyor 28 upon which second slab portion 102 is disposed to form an overlap portion 128 between side 130 of slab 80a and side 132 of slab 102 as shown in FIGS. 14A-15B. In an embodiment, overlap portion 128 includes a single strand from slab 80a that overlaps a single strand of slab 102. Pressing device 90 may be moved downward (as indicated by downward direction arrows E in FIG. 15A) as herein described to apply a force that adheres side 130 with side 132 to form integral slab 134. Actuator 92 may be used to apply suitable downward force so that flattening device 90 flattens overlap portion 128 so that the overlap portion has the same thickness as the non-overlapped portions of each slab. Alternatively, flattening device 90 may be used to apply sufficient pressure to ensure adhesion between the slabs without standardizing the width between the slabs and the overlap portion. Integral slab 134 may be moved with conveyor 28 to further processing stages such as pressing, sheeting, rolling and scoring to produce a substantially flat confectionery product. Adherence between sides 130 and 132 is typically sufficient to ensure that integral slab 134 remains intact as a single piece during subsequent processing.

In an embodiment, a single strand from each adjoining slab portion forms may be used to form the contact area, the step joint, or the overlap area. The visual property of the contacting strands may be the same or different. In an embodiment, the visual property of the contacting strands is the same as seen in FIGS. 1-2, and 11-15B.

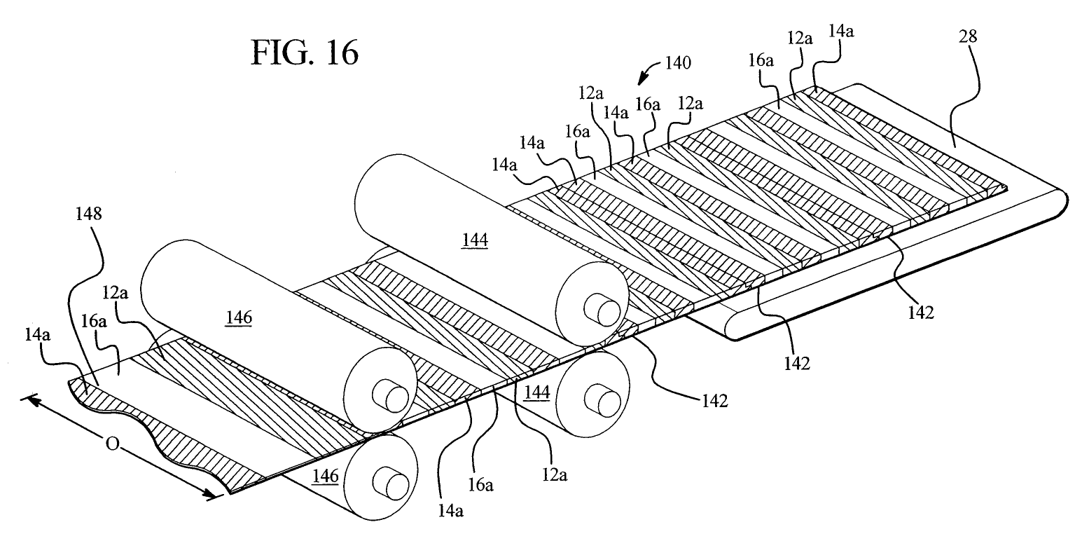

Integral slab 140 is moved along conveyor 28 for further pressing and sheeting as is shown in FIG. 16. Integral slab 140 may be any slab formed by the contacting and adhering two individual slab portions as previously discussed (i.e., by way of contact, step joint, or overlap). FIG. 16 shows integral slab 140 having jointed portions 142 being pressed by roller pairs 144 and 146 which flatten integral slab 140 into a relatively thin flat sheet 148. As integral slab 140 is pressed by rollers 144 and 146, the width of the strands increases. The skilled artisan will appreciate that the final width of the strands in the finished flattened sheet may be adjusted as desired by 1) altering the diameter/width of the orifices of the outlet member, 2) adjusting the thickness of the final sheeted product or a combination of 1) and 2).

After sheet 148 leaves rollers 144 and 146, the sheet may be trimmed and scored on lines along the length and width of the sheet to produce a confectionery article with a size and shape as desired. Sheet 148 may be dusted during sheeting to reduce any adhesiveness as is commonly known in the art. Typically, starch is used as the dusting compound. Sheet 148 may have a width “O” (as shown in FIG. 16) of from about 6 feet to about 15 feet with a width of 9 feet preferred. Sheet 148 may be longitudinally and laterally scored to produce individual confectionery pieces having a length from about 1 inch to about 15 feet and a width from about 0.5 inches to about 3 inches.

Upon completion of the sheeting and the scoring, a confectionery article is formed that is substantially flat and has a width and a thickness. The article includes at least two strands of confectionery material that extend across the article width. In an embodiment, each strand extends across the entire width of the confectionery article. As the strands are codispensed from apparatus 10, each strand also extends through the entire thickness of the article. In other words, the strands themselves define the thickness of the final confectionery article. Each strand is therefore visible from the top, bottom, the sides of the confectionery article. Each strand in the article has a visually different property as previously discussed. Alternatively, the visually different strands may form a visual unit, and the confectionery article may have a plurality of visual units to yield a confectionery article having a repeating sequence of strands with different visual properties. An advantage of this multiple phase confectionery article is that a clear delineation exists between the strands to yield a visually attractive confectionery article with precise well-defined lines between the strands each strand having a distinct visual property.

The number of visually distinct strands in the final confectionery article may vary based on the number of strands codispensed from the apparatus 10. In an embodiment, the number of visually different strands dispensed from apparatus 10 form a visual unit. Thus, a visual unit may include from about 2 to about 10 visually different strands. FIG. 1 illustrates an embodiment whereby slab 80 has three visually different strands 12a, 14a, and 16a, slab 80 having seven individual strands. The final confectionery product formed from slab 80 will thereby include a visual unit that is contains three visually different strands. In an embodiment, the confectionery article may have a repeating sequence of from about two visual units to about 10, 20, 30 or 50 or more visual units. It is understood that the number of repeating visual units in the final confectionery article will be based on 1) the number of individual slab portions used to prepare the integral slab, 2) the length of each strand and 3) the length of the sheet.

In an embodiment, each strand has a visually different property selected from color, strand texture, surface characteristics, material composition, and combinations thereof as previously discussed. In a further embodiment, the confectionery article includes strand 12a that is red, strand 14a that is green, and strand 16a that is yellow. It is understood that the visual distinction between the strand may or may not be the result in differentiation of a single property. For example, the confectionery article may have a first red strand, a second strand with a granular surface texture, and a third strand with a shiny surface finish. Indeed, the confectionery materials of each individual strand may be the same or different and may contribute in whole or in part to the visually distinct property of the strands. In an embodiment, the strands that form the confectionery article also include a different organoleptic property. The organoleptic property may be flavor, aroma, softness, mouthfeel, and combinations thereof. For example, the confectionery article may have a first chewing gum strand blue in color having the aroma of blueberries, a second nougat strand having a granular texture (which may be coconut particles) with the flavor of coconuts, a third transparent candy strand having a smooth and shiny surface finish, and a fourth taffy strand black in color with a licorice flavor. It is understood that myriad combinations exist for the composition, color, texture and flavor for the strands of the completed confectionery article.

As a result of strand formation and the subsequent preparation of integral slabs from individual slab portions as described above, the confectionery article includes strands that may be coextruded strands, welded strands, cohered strands such as compressively cohered or adhesively cohered strands, and combinations thereof. The strands of the confectionery article may or may not have substantially similar lengths. In an embodiment, the strands of the confectionery article have substantially identical lengths. Accordingly, strands utilized for adhering one slab portion to another slab portion have substantially the same length as strands not used in slab adhesion. The strands in the final confectionery article may have a length from about 0.5 inches to about 12 inches.

The material composition of the confectionery article will be a compilation of the confectionery materials used in strand formation. Consequently, the confectionery article made include confectionery material including chewing gum, bubble gum, nougat, pliable confectionery material, taffy, chewy candy, caramel, and combinations thereof. In an embodiment, the plastic confectioneries 12a, 14a, and 16a are chewing gum and the confectionery article is sheeted to a thickness from about 0.03 inch to about 0.5 inches and preferably about 0.055 inches. In an embodiment, sheet 148 may be scored to produce the typical 0.75 inch by 3 inch stick of chewing gum.

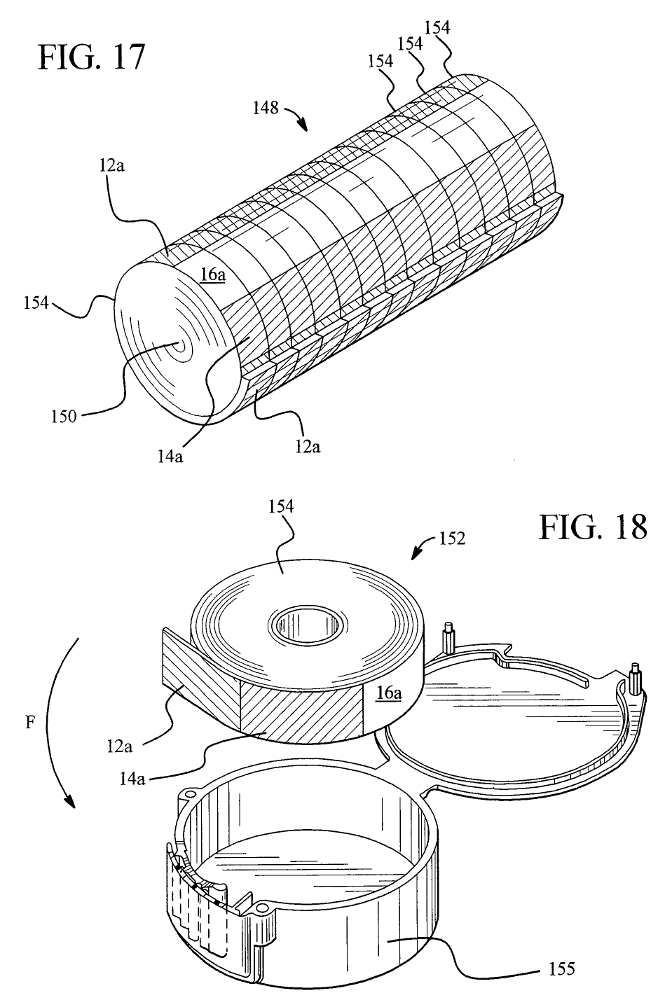

In a further embodiment, sheet 148 is chewing gum and is rolled about a leading edge 150 thereof (typically with rolling drum(s) and curling plate(s)) to form confectionery article 152 that is a rolled tape of chewing gum 154 as shown in FIG. 17. Sheet 148 may be scored longitudinally (i.e., scoring that is perpendicular to the strands) with the width between longitudinal scores being from about 0.5 inches to about 1 inch with 0.75 inches being preferred. Longitudinal scoring may occur before or after the rolling process with longitudinal scoring occurring before rolling being preferred. Lateral scoring (i.e., scoring that is substantially parallel to the strands) may occur at intervals from about 2 feet to 15 feet, 3 feet to 12 feet, with about 12 foot intervals being preferred. Thus the rolled confectionery tape may have a length from about 2 to 15 feet, or about 3 feet to about 12 feet. Once sheet 148 is rolled, individual tapes 154 may be separated from each other into individual tapes. FIG. 17 shows an embodiment whereby rolled sheet 148 may be separated into 13 individual confectionery articles of rolled tapes 154.

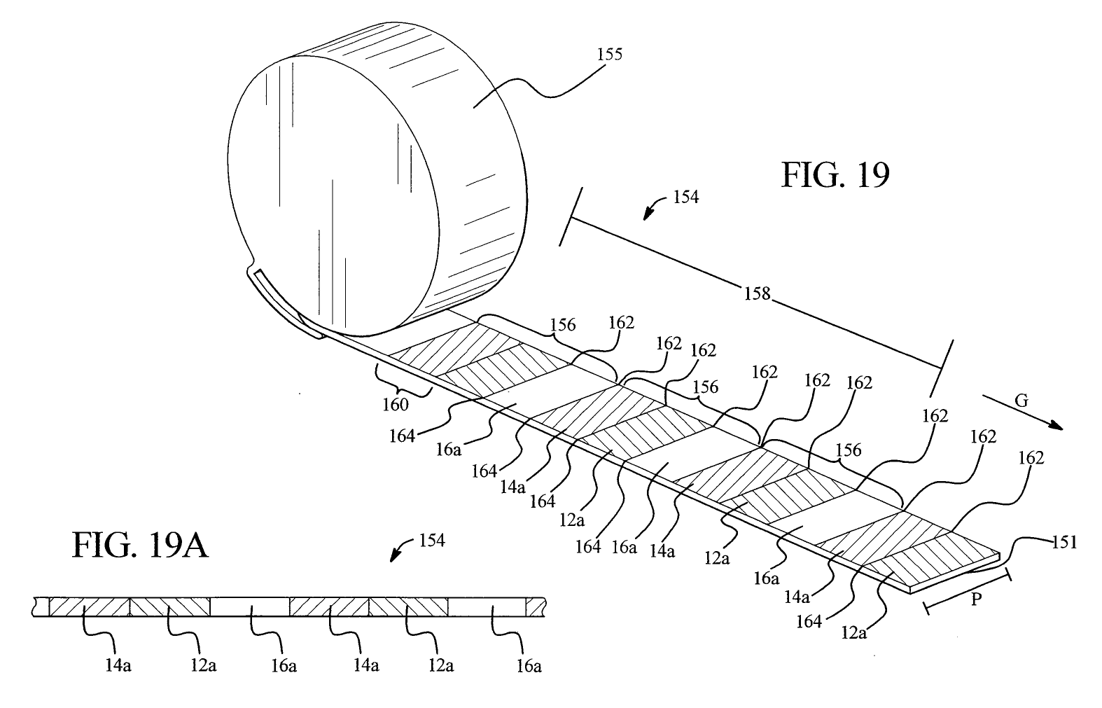

In a further embodiment, the rolled chewing gum tape contains three visually distinct strands 12a, 14a, and 16a as shown in FIGS. 17-19. In an embodiment, rolled chewing gum tape 154 may be placed in a dispenser 155 (as indicated by direction arrow F in FIG. 18) and dispensed therefrom by pulling leading edge 151 away from dispenser 155 as indicated by arrow G in FIG. 19. Strand 12a may be red, strand 14a may be green, and strand 16a may be yellow as previously discussed. Strands 12a, 14a, and 16a form a visual unit 156, visual unit 156 forming a repeating sequence 158 of visual units 156 in confectionery article 154 as shown in FIG. 19. It is understood that the number of visual units in the repeating sequence will vary based on the length 160 of each strand and the length of the rolled chewing gum tape. In an embodiment, the width P (FIG. 19) of each strand is from about 0.25 inches to about 12 inches, or about 0.3 inches to about 3 inches (simulating the size of a standard piece of chewing gum) and has a thickness of about 0.05 inches to about 2.0 inches. In an further embodiment, each strand may have a length 160 of about 0.5 inches to about one foot, or about 1 inch to about 3 inches, with the length of the rolled chewing gum tape confectionery article 154 being from about 3 feet to about 15 feet or about 9 feet to about 12 feet.

In an embodiment, the strands are substantially parallel to leading edge 151. Leading edge 151 essentially defines the width of gum tape 154 with each strand extending across the entire width of the confectionery article as shown in FIG. 19. As the strands define the thickness of gum tape 154 as shown in FIGS. 19 and 19A, the strands are visible from the top, bottom and sides of the confectionery article. Gum tape 154 advantageously provides precise, clear lines of delineation 162 between adjacent strands providing a confectionery article with a sharp and clean appearance. In a further embodiment, a perforation 164 or score line may be applied along the delineation lines to enable rapid detachment of individual strands from gum tape 154.

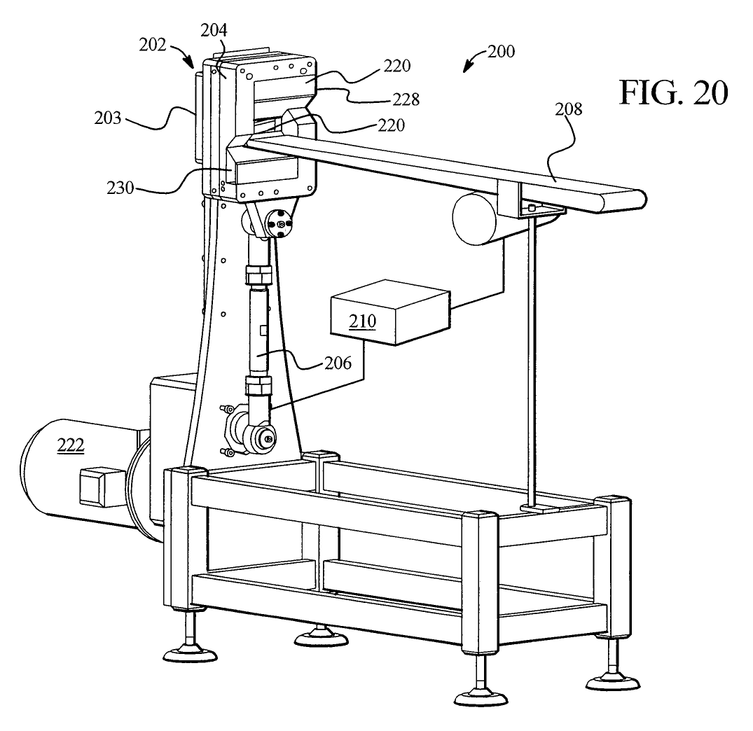

FIGS. 20-23 illustrate an alternate embodiment of a confectionery dispensing apparatus 200 having a manifold 202, a dispensing member 204 in operative communication with a drive mechanism 206, a conveyor 208, and a controller 210. Manifold 202 has passageways 212 and 214 for receiving respective plastic confectionery materials 216 and 218. Plastic confectionery materials may be any confectionery material as previously discussed herein. In an embodiment, confectionery materials 216 and 218 each have a visually distinct property. The visual distinction between materials 216 and 218 may be based on any property or combination of properties as previously discussed. In a further embodiment, the visually different confectionery materials 216 and 218 further include a different organoleptic property as discussed. In yet a further embodiment, plastic confectionery material 216 is a first color and plastic confectionery material 218 is a second color.

Each passageway has inlets on inlet side 203 of manifold 202 that may be placed in fluid communication with a respective source of a plastic or otherwise flowable confectionery material. Accordingly, confectionery material 216 originates from a corresponding confectionery source and flows through passageway 212 as indicated by arrow J. Similarly, confectionery 218 originates from a respective confectionery source and flows through passageway 214 as indicated by arrow K.

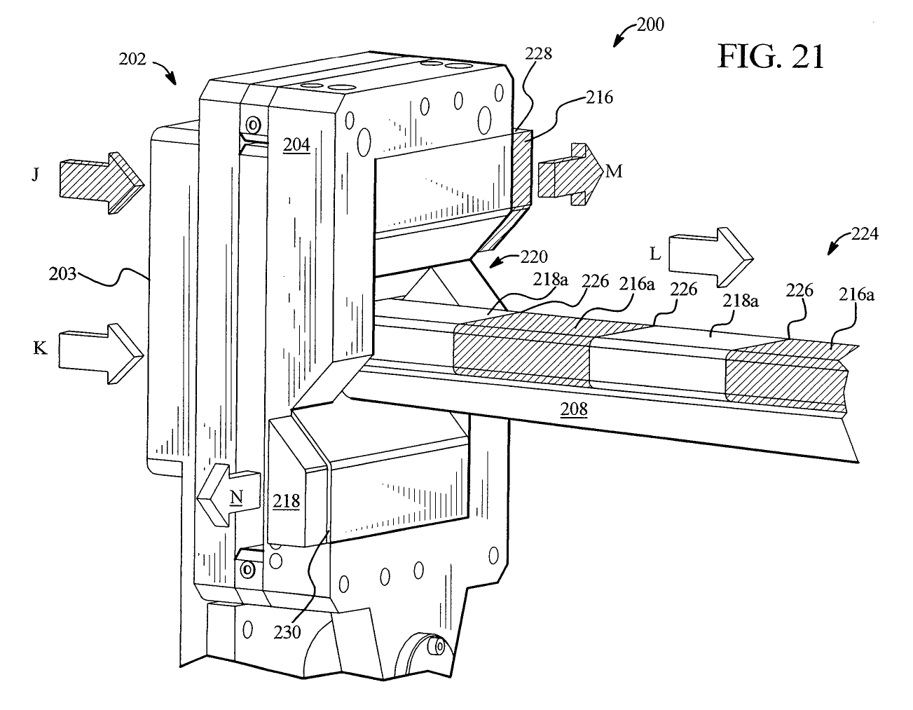

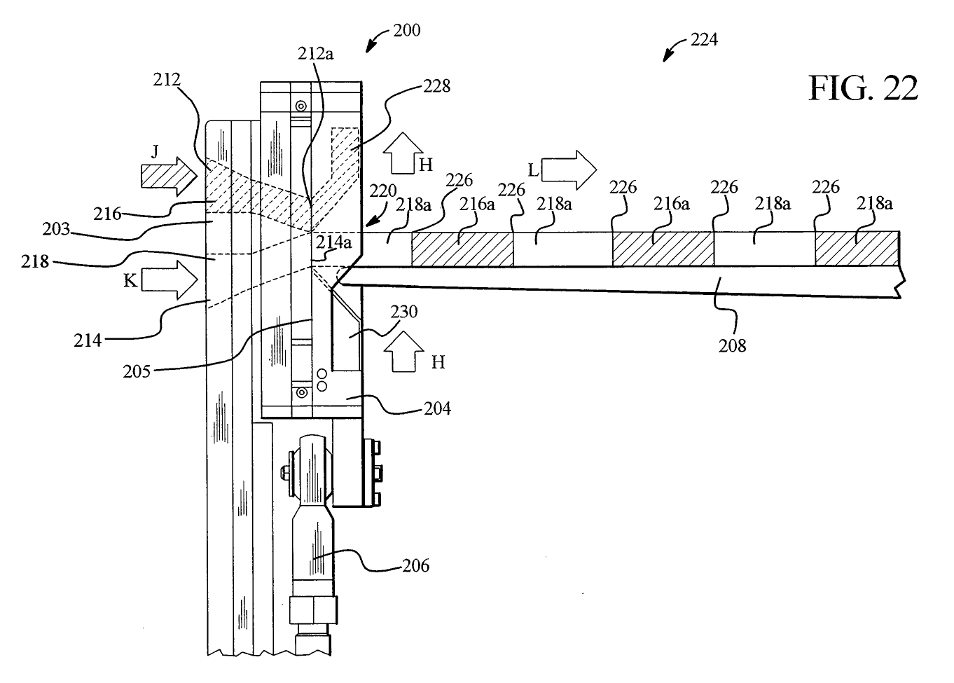

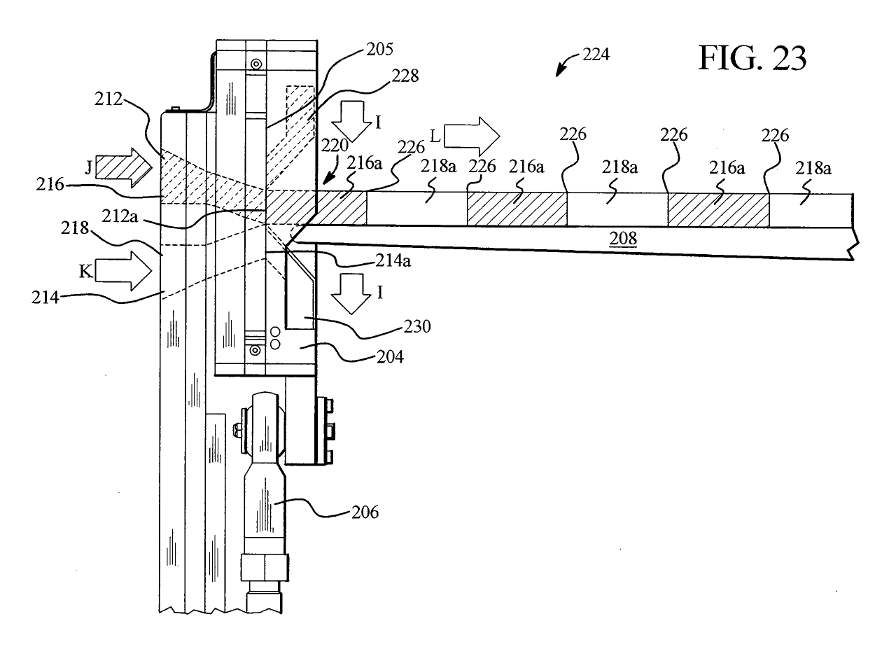

Although FIGS. 21-23 show two passageways, it is understood that manifold 202 may contain 3, 4, or 5 or more passageways. Manifold 202 has an inlet surface 203 and an outlet surface 205. Passageways 212 and 214 are configured so that respective passageway outlets 212a and 214a are adjacent to each other at the exit point of manifold outlet surface 205 as shown in FIGS. 22 and 23. In other words, outlets 212a and 214a are in close proximity to each other. In an embodiment, passageway outlets 212a and 214a are in very close proximity to each other and are oriented in a substantially vertical or stacked arrangement.

Dispensing member 204 has an opening 220 and is adjacent to and in operative communication with manifold 202 along manifold outlet surface 205. In an embodiment, dispensing member 204 is in sliding engagement with manifold outlet surface 205. This arrangement enables dispensing member to move or otherwise slide with respect to outlet surface 205 and passageway outlets 212a and 214a. In an embodiment, dispensing member 204 is movable in an up and down or vertical manner as indicated by upward arrows H in FIG. 22 and downward arrows I in FIG. 23.

Dispensing member 204 moves with respect to passageway outlets 212a and 214a along the manifold outlet surface 205 to place opening 220 in fluid communication with each outlet. The shape, diameter, and size of opening 220 is configured to align with each outlet to provide essentially leak-free fluid communication. When opening 220 is in fluid communication with outlet 212a, plastic confectionery material 216 is dispensed as shown in FIG. 23. Similarly, when opening 220 is placed in fluid communication with outlet 214a, confectionery material 218 is dispensed as shown in FIG. 22. As dispensing member 204 has a single opening, only a single confectionery material is dispensing at a given time. Dispensing member 204 blocks the outlet that is not in fluid communication with the opening. As shown in FIGS. 22 and 23, confectionery material 218 is dispensed through opening 220 while confection material 216 is not dispensed as passageway outlet 212a is blocked by dispensing member 204. Similarly, confectionery material 216 is dispensed through opening 220 while confectionery material 218 in outlet 214a is blocked by the dispensing member.

Drive mechanism 206 is attached to dispensing member 204 to move dispensing member 204 with respect to manifold outlet surface 205. Drive mechanism 206 may be any mechanical, electrical, hydraulic, or pneumatic device that moves dispensing member 204 along manifold outlet surface 205 as is commonly know in the art. A motor 222 may used as a power source for drive mechanism as shown in FIG. 20.

In an embodiment, dispensing member 204 moves in a predetermined manner or order to sequentially place opening 220 in fluid communication with each passageway outlet. Accordingly, the order in which fluid communication between the opening and each outlet occurs determines order in which the confectionery materials are dispensed. In an embodiment, dispensing member 204 moves in an alternating or otherwise oscillating manner between outlet 212a at a first position to outlet 214a at dispense an amount of plastic confectionery material 216 followed movement to a second position to dispense an amount of plastic confectionery material 218. FIG. 23 shows dispensing member 204 in the first position which places opening 220 in fluid communication with outlet 212a to dispense fluid confectionery material 216. FIG. 22 shows dispensing member in the second position whereby opening 220 is in fluid communication with outlet 214a to dispense and amount of plastic confectionery material 218. The amount of time opening 220 remains in fluid communication with each opening may be varied as desired. Of course, the longer fluid communication exists between the opening and an outlet, the more confectionery material that is dispensed. The duration of fluid communication between the opening and each outlet may be adjusted as desired. In an embodiment, the time duration of fluid communication between opening 220 and outlet 212a is substantially the same as the time duration of fluid communication between opening 220 and outlet 214a. Apparatus 200 thereby dispenses sequential amounts of each confectionery material to produce or otherwise form a continuous confectionery article 224 having segments 216a and 218a of respective confectionery materials 216 and 218, the segments having substantially the same length and arranged in an alternating or otherwise sequential order. Confectionery article 224 may be sheeted and scored as desired. Alternatively, confectionery article may be a finished confectionery product and may be scored and packaged.

In an embodiment, drive mechanism 206 quickly slides dispensing member 204 between the first and second positions. Upon dispensing an amount of plastic confectionery material 216 from outlet 212a, dispensing member 204 slides quickly downward to place opening 220 in fluid communication with outlet 214a. The elapsed time for terminating fluid communication between opening 220 and outlet 212a and subsequently establishing fluid communication between opening 220 and outlet 214a is from about 0.03 seconds to about 0.5 seconds. In an embodiment, the elapsed time is from about 0.05 seconds to about 0.1 seconds. The same time duration occurs for termination of fluid communication between opening 220 and outlet 214a and establishment of fluid communication between opening 220 and outlet 212a.

This rapid sliding of dispensing member 204 between the first and second positions and the concomitant movement of opening 220 between outlets 212a and 214a advantageously provides a continuous and even-finished confectionery article with well-defined and precise delineation at contact points 226 between confectionery segments 216a and 218a. A further advantage of apparatus 200 is that the flow pressure for each confectionery material is maintained when the corresponding passageway outlet is blocked by the dispensing member. Consequently, when fluid communication occurs between opening 220 and the passageway outlet, the confectionery material instantly flows from the outlet. In addition, the plate-like structure of dispensing member 204 ensures that no residue from the previously dispensed material remains in opening 220. This ensures no confectionery material 218 is present in any part of segment 216a segment and vice versa. Accordingly, confectionery article 224 exhibits no bleeding, streaking, or contamination across contact points 226.

In an embodiment, conveyor 208 receives continuous confectionery article 224 and moves it away from apparatus 200. In a further embodiment, controller 210, in operative communication with dispensing member 204 and conveyor 208, coordinates the dispensing of confectionery material and the conveyor movement. The speed of the conveyor may be coordinated with the flow rate of each confectionery material to further ensure that confectionery article 224 has consistent diameter along the entire back thereof. In addition, controller 210 may coordinate the movement of dispensing member 204 and conveyor movement. Thus, controller 210 may be used to simultaneously shift dispensing member 204 between first and second positions and turn the conveyor on and off. In an embodiment, controller 210 (e.g., 0.03-0.5 seconds) halts or otherwise stops movement of conveyor 208 during the short time duration that opening 220 is moving between the outlets. Once fluid communication is established between the opening and an outlet, controller 210 directs conveyor movement to resume. Once opening 220 is placed in fluid communication with an outlet, dispensing member may dwell or otherwise remain in this dispensing position from about 1 second to about 2 minutes, or about 5 seconds to about 1 minute. It is understood that apparatus 200 may additionally include sensor devices (a flowmeter, for example) to determine when fluid communication occurs between the opening and a passageway outlet.

In a further embodiment, dispensing member 204 includes ports 228 and 230, each port associated with and corresponding to a respective passageway/passageway outlet/confectionery material as shown in FIGS. 20-23. For example, port 228 corresponds to passageway 212/outlet 212a and port 230 corresponds to passageway 214/outlet 214a. When opening 220 is placed into fluid communication with outlet 214a, port 228 is simultaneously placed in fluid communication with outlet 212a, port 228 receiving plastic confectionery material 216 as shown in FIG. 22. Similarly, when opening 220 is placed in fluid communication with outlet 212a, port 230 is moved into fluid communication with outlet 214a to receive plastic confectionery material 218 as shown in FIG. 23. In a further embodiment, each port is in fluid communication with the source of each confectionery material—port 228 in fluid communication with the source of confectionery material 216 and port 230 in fluid communication with the source of confectionery material 218. In FIG. 21, arrow M indicates the flow of confectionery material 216 through port 228 to the source of confectionery material 218 and arrow N shows the flow of confectionery material 218 through port 230 back, to the source of confectionery material 218.

The presence of the ports in the dispensing member provides several advantages. The non-dispensed plastic confectionery is recycled back to the source reducing waste and ensuring fresh confectionery material is deposited. Maintaining the confectionery material in a flowing state further provides consistency in the flow dynamics of each confectionery material. Moreover, the ports maintain the confectionery materials in a constant flow state when not being dispensed from the opening. This reduces passageway adhesion problems and maintains consistency in the fluid properties of the confectionery materials. In addition, when fluid communication is established between the dispensing member opening and an outlet, the plastic confectionery material is already flowing. This eliminates confectionery flow initiation problems—namely, the lag time between the establishment of fluid communication between an outlet and the opening and actual out flow or dispensing of the confectionery material from the opening. Lag time can be substantial with highly viscous confectioneries such as chewing gum, for example. Accordingly, the ports contribute to the formation of continuous confectionery article 224 by providing confectionery material that instantaneously or substantially instantaneously flows from the opening upon fluid communication therewith.

In an embodiment, confectionery article 224 has no gaps, incongruities or seams along the length of its body. In particular, contact points 226 exhibit no surface inconsistencies, no indentations and no disparity in the surface or body structure of confectionery article 224. Contact points 226 identify discrete delineation between the visual different properties between confectionery material 216 and confectionery material 218. Thus, confectionery article 228 has s substantially uniform diameter along the entire length thereof.

Similar to confectionery article 152, segments 216a, 218a extend across the entire width of confectionery article 224. Indeed, the segment 216a and 218a themselves define the thickness of confectionery article 224. Each segment 216a and 218a may be viewed from the top, bottom and sides of confectionery article 224. Confectionery article 224 may be made of any confectionery material or combination of confectionery materials as previously described. In an embodiment, confectionery article 224 is chewing gum and segments 216a and 218a are each a different color. Confectionery article 224 may be sheeted and scored and formed into a rolled tape of confectionery material (such as chewing gum) as previously described.

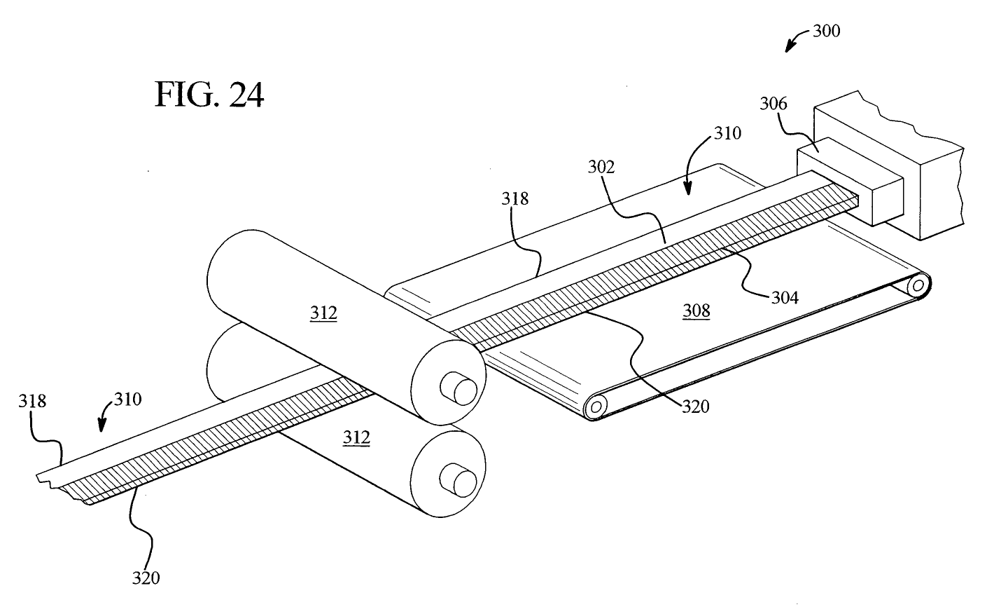

FIGS. 24-28 illustrate an alternate embodiment wherein confectionery dispensing apparatus 300 codispenses or otherwise coextrudes a first plastic confectionery strand 302 and a second confectionery strand 304 from outlet member 306 onto a conveyor 308 to form confectionery product 310 as shown in FIG. 24. Although FIG. 24 shows the coextrusion of two confectionery materials, it is understood apparatus 300 may be adapted to coextrude 3, 4, or 5 or more confectionery materials without detracting from the present disclosure. Apparatus 300 may be any device capable of coextruding two or more plastic confectionery materials such as a screw extruder as is commonly known in the art. In an embodiment, apparatus 300 may be apparatus 10 adapted to dispense or extrude a desired number of plastic confectionery strands, such as two visually different strands. It is understood that the size of orifices of outlet member 306 may be adjusted as desired to form strands of varying thickness and/or width based on the composition of the confectionery material or the final product. In other words, apparatus 300 may be configured to form a plastic slab of confectionery material that requires additional processing. Alternatively, apparatus 300 and outlet 306 may be configured to dispense a finished confectionery product that requires minimal scoring and packaging for completion.

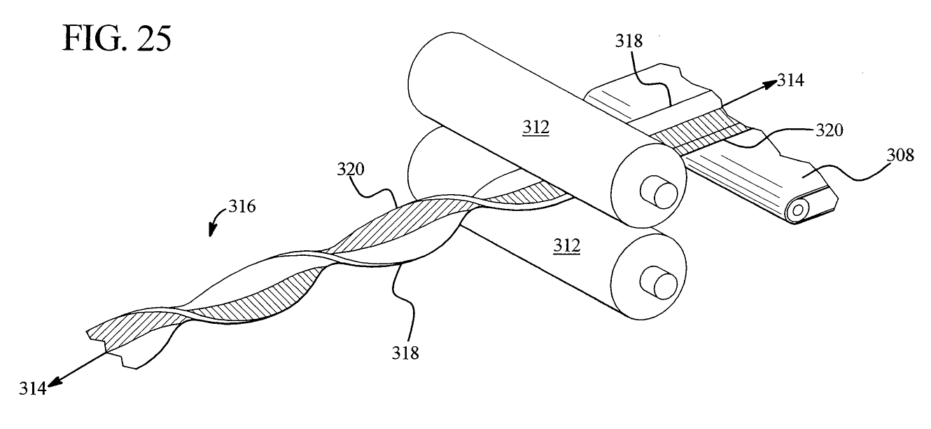

As shown in FIG. 24, codispensed first and second confectionery strands 302 and 304 are in adherence with each other and extend longitudinally along the body of confectionery product 310. In an embodiment, confectionery product 310 may be pressed by rollers 312 to flatten or otherwise decrease the thickness of the confectionery product. Alternatively, confectionery product 310 may move to the next processing step without passing through rollers 312. Confectionery product 310 is then twisted about longitudinal axis 314 to form twisted confectionery product 316 as shown in FIG. 25. The twisting may be applied either manually or automatically as is commonly known in the art. Although FIG. 25 shows twisted confectionery product 316 that exhibits a single-twist pattern, it is understood that the confectionery product may be subject to multiple twisting to produce a twisted confectionery product having more and tighter twists. In an embodiment, the twisting may be any winding, coiling, contorting, screw action or other manipulation of confectionery product 310 that moves first and second edges 318 and 320 of out of the same plane. As a result of the twisting operation, twisted confectionery product 316 is formed that has edges 316 and 318 that are non-planar with respect to each other. The twisting procedure may be applied to the confectionery product continuously—as the confectionery product is being extruded as shown in FIG. 25. Alternatively, confectionery product 310 may be scored into individual pieces and subsequently twisted as desired.

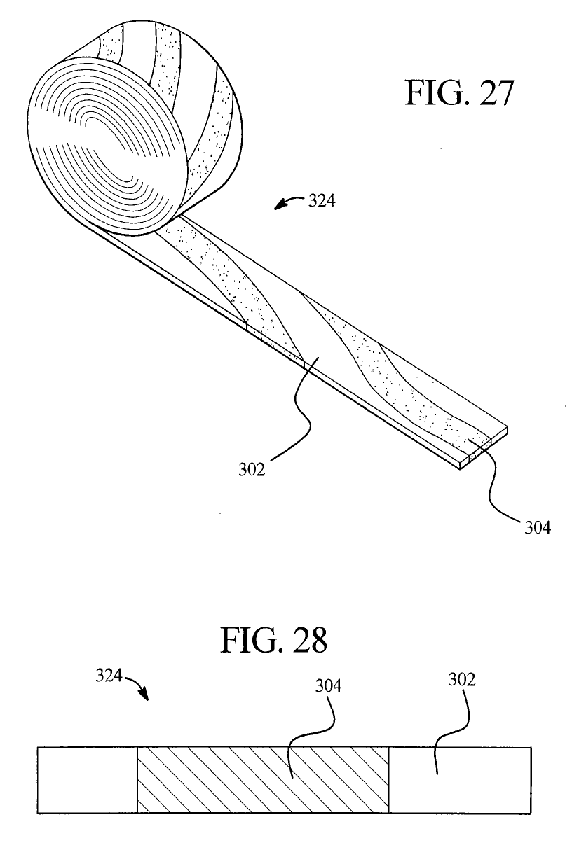

Twisted confectionery product 316 then proceeds through rollers 322 which press or otherwise flatten twisted confectionery product 316 into a substantially flat confectionery article 324, the strands providing or otherwise forming an undulating pattern. The undulating pattern may be any aesthetically pleasing pattern and may include a swirl pattern, a random pattern, a twisted pattern, or a wavy pattern. In an embodiment, confectionery article 324 has swirled pattern and swirled strands 302, 304 as shown in FIG. 27. Confectionery article 324 is subsequently received by conveyor 326 which moves confectionery article 324 away from rollers 322. In a further embodiment, each strand 302 and 304 extends through the entire thickness of confectionery article 324 as seen in FIGS. 27 and 28. This permits the observation of each strand 302 and 304 from the top, bottom, and sides of the confectionery article. In addition, the thickness of the confectionery article is defined by the thickness of each confectionery strand 302, 304. Provision of twisted confectionery product 316 results in confectionery article 324 having confectionery strands 302, 304 in a swirled orientation. An advantage of confectionery article 324 is that precise, well-defined delineation or delineation lines are present between the visually different strands.

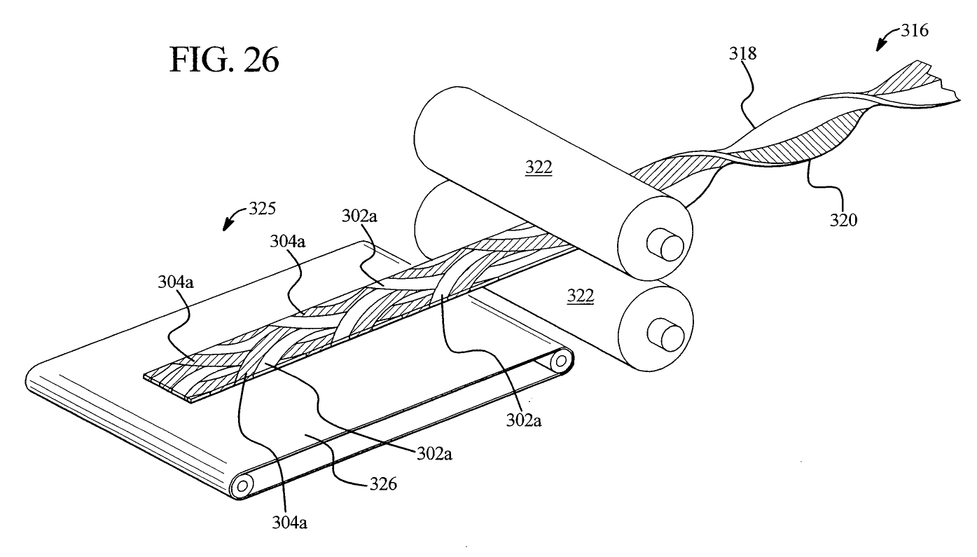

In an embodiment, confectionery product 310 may be subjected to a high degree of twisting. Pressing by rollers 322 results in confectionery article 325 having a high concentration or high density of substrands 302a and 304a that are in a random or disordered arrangement as shown in FIG. 26. Thus the skilled artisan will appreciate that the appearance of confectionery article 325 may be altered by adjusting the degree of twisting and the degree of pressing as desired. One, some, or all of substrands 302a, 304a extend through the entire thickness of confectionery article 325. It is thereby understood that the thickness of confectionery article 325 may or may not be the same thickness as each substrand. Accordingly, each substrand may or may not be visible from both the top and bottom of confectionery article 325. In an embodiment, at least two substrands a substrand 302a and substrand 304a, extend the entire thickness of confectionery article 325, with at least one substrand 302a and at least one substrand 304a observable for the top, bottom and a side of confectionery article 325.

Confectionery article 324 or 325 may be shaped into any finished product as desired. In an embodiment, confectionery article 324 and/or 325 is a rolled tape of chewing gum as previously discussed and shown in FIG. 27.

By way of example and not limitation, examples of the present invention will now be given.

### EXAMPLES

### Example 1

Bubble gum is made according to the formula set forth below.

| Ingredient | Weight % |
|---|---|
| Sugar | 63.47% |
| Gum Base | 21.89% |
| Corn Syrup 63 DE | 9.24% |
| Glycerin | 2.96% |
| Flavor | 1.68% |
| Sweetener* | 0.32% |
| Lecithin | 0.31% |
| Water | 0.10% |
| Color | 0.03% |
| Total | 100% |

*High intensity sweeteners, such as aspartame and acesulfame potassium.

The bubble gum was divided into three masses, the first mass being red in color, the second mass being green in color, and the third mass being yellow in color. The first, second, and third bubble gum masses were coextruded to form a slab with the apparatus set forth in FIGS. 1-16 and the accompanying disclosure thereto. The slab was sheeted, scored, and rolled to form a multiple color bubble gum tape. Individual bubble gum tapes were packaged in cylindrical cup dispensers as discussed herein. Each tape was about 0.055 inches thick, about 0.75 inches wide, and had a length of about nine feet. The multicolored bubble gum tape had a visual unit that included a red, a green, and a yellow segment or strand. Each colored strand had a length of about one foot. The bubble gum tape included a repeating sequence of three visuals units.

### Example 2

The bubble gum of Example 1 was separated into two masses. The first mass was colored red and the second mass was colored yellow. The two colored masses were coextruded into a multiple color slab using the equipment set forth in FIGS. 20-23 and the accompanying disclosure thereto. The slab was sheeted, scored, and rolled to form a multiple color bubble gum tape. Individual bubble gum tapes were packaged in cylindrical cup dispensers as discussed herein. Each tape was about 0.055 inches thick, about 0.75 inches wide, and had a length of about six feet. The multicolored bubble gum tape had a visual unit that included a red strand and a yellow strand. Each strand had a length of about 3 inches. The bubble gum tape included a repeating sequence of 12 visual units.

### Example 3

A taffy type confectionery product was prepared according to the formula set forth below.

| Ingredient | Formula % |
|---|---|
| Sugar | 42.00 |
| Corn Syrup - 42 D.E. | 35.00 |
| Water | 10.00 |
| Sodium Citrate | 0.10 |
| Maltodextrin - 18 D.E. | 0.70 |
| Lecithin | 0.30 |
| Color | 0.05 |

The ingredients were cooked at 255° F. To this mixture, gelatin having the following composition was added.

| Ingredient | Formula % |
|---|---|
| Gelatin - 150 Bloom | 1.00 |
| Water | 2.00 |
| Powdered Citric Acid | 1.00 |
| Fondant Sugar | 1.10 |
| Vegetable Fat | 6.50 |
| Flavor | 0.25 |
| Total | 100.00 |

The gelatin was dissolved before the water addition. The gelatin/water was added to the cooked candy and whipped or pulled to incorporate air into the taffy. Powdered citric acid, fondant sugar, vegetable oil, and flavor were added after the whipping or pulling step. The resultant taffy was separated into two masses. The first mass was colored red and the second mass was colored white. The first and second masses were coextruded using the apparatus set forth in FIGS. 1-16 and the corresponding description to form a red and white multiple colored confectionery slab. The confectionery slab was sheeted and scored into strips of confectionery material. Each strip had a repeating sequence of red and white strands.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

The invention is claimed as follows:

1. An apparatus for producing a multiple phase confectionery article comprising:
a manifold having a plurality of passageways, each passageway adapted to receive a respective plastic confectionery material;
a dividing member adjacent the manifold for dividing each confectionery material into a plurality of plastic confectionery strands, the dividing member having a plurality of channels in fluid communication with the passageways, each channel adapted to received a respective plastic confectionery strand; and
an outlet member adjacent the dividing member and having a plurality of orifices in a linear orientation, each orifice in fluid communication with a corresponding channel to dispense the plurality of plastic strands from the outlet member, the plurality of codispensed plastic strands forming a plastic confectionery slab comprising a substantially linear arrangement of strands in adherence to each other.

2. The apparatus of claim 1 wherein each plastic confectionery material has a visually different property and the slab strands each have a visually different property.

3. The apparatus of claim 2 wherein the dividing member arranges plastic confectionery strands with the same visual property in an alternating order.

4. The apparatus of claim 2 wherein adherence is between strands with visually different properties.

5. The apparatus of claim 1 wherein each plastic confectionery material is divided into two to about five plastic confectionery strands.

6. The apparatus of claim 1 wherein the plastic slab further comprises from two to about 10 strands.

7. The apparatus of claim 1 wherein the plurality of plastic confectionery materials further comprises from two to about 10 confectionery materials.

8. The apparatus of claim 1 wherein the outlet member further comprises outermost baffled orifices for forming a jointed plastic confectionery slab.

9. An apparatus for producing a confectionery product from a first confectionery slab portion having a first side and a second confectionery slab portion having a second side, the apparatus comprising:
a transfer device for moving the first side into contact with the second side to form a contact area; and
a pressing device applying pressing force onto the contact area to adhere the first side to the second side.

10. An apparatus for producing a confectionery product comprising:
a confectionery dispensing device having a baffled outlet member for forming a first confectionery joint slab and a second confectionery joint slab, each confectionery joint slab having a jointed side and a reciprocal jointed side; and
a transfer device for moving the jointed side of the first confectionery joint slab into contact with the reciprocal jointed side of the second confectionery joint slab.

11. The apparatus of claim 10 further comprising a pressing device for pressing the jointed side onto the reciprocal jointed side.

12. The apparatus of claim 11 wherein the jointed side and the reciprocal jointed side are in adherence with each other to form an integral slab portion containing first and second jointed slab portions.

13. A method of making a confectionery article comprising:
providing a first plastic slab of a confectionery material and a second plastic slab of a confectionery material, each slab having opposing sides;
contacting a side of the first slab with a side of the second slab; and
pressing the contacting sides together to produce a substantially flat confectionery product.

14. The method of claim 13 further comprising adhering the first side to the second side to form an integral plastic slab including the first and second plastic slabs.

15. The method of claim 13 the contacting further comprises overlapping the side of the first slab with the side of the second slab.

16. The method of claim 15 wherein the overlapping forms an overlap portion, the method further comprising pressing the overlap portion.

17. The method of claim 13 wherein the second plastic slab includes a strand of confectionery material extending along each side, the strands of the second plastic slab each having a visually different property, wherein the contacting further comprises contacting a strand of the first plastic slab with a strand of the second plastic slab.

18. The method of claim 17 wherein the first and second slabs each have a strand with a common visual property wherein the contacting further comprises contacting the strands with the common visual property.

19. The method of claim 13 wherein the first slab has a joint side and the second slab has a reciprocal joint side, the contacting further comprising engaging the joint side with the reciprocal joint side.

20. The method of claim 19 wherein the engaging forms a joint, the method further comprising pressing the joint.

21. The method of claim 13 further comprising forming the confectionery product into a rolled tape.

22. The method of claim 21 further comprising placing the confectionery rolled tape into a dispenser.

23. The method of claim 22 further comprising dispensing the confectionery rolled tape from the dispenser.

24. A method of making a confectionery article comprising:
providing a first plastic slab of a confectionery material and a second plastic slab of a confectionery material, each slab having opposing sides, the first plastic slab at a first location, the second plastic slab at a second location;
moving the first plastic slab from the first location to the second location; and
contacting a side of the first slab with a side of the second slab.

25. The method of claim 24 further comprising pressing the contacting sides together to produce a substantially flat confectionery product.

26. The method of claim 24 further comprising adhering the first slab to the second slab to from an integral slab.

27. The method of claim 24 wherein the moving further comprises lifting the first plastic slab with a transfer device from the first location, transporting with the transfer device the first plastic slab from the first location proximate to the second location, and lowering the first slab to the second location.

28. An apparatus for producing a multiple phase confectionery article comprising:
a manifold containing a plurality of passageways, each passageway adapted to receive a respective plastic confectionery material, each passageway having an outlet on an outlet surface of the manifold; and
a dispensing member having an opening and in movable engagement with the outlet surface, the dispensing member placing the opening in fluid communication with each passageway outlet to sequentially dispense an amount of each plastic confectionery material to form a continuous confectionery article.

29. The apparatus of claim 28 wherein the passageway outlets are adjacent to each other on the manifold outlet surface.

30. The apparatus of claim 28 further comprising a drive mechanism in operative communication with the dispensing member, the drive mechanism adapted to move the dispensing member along the manifold outlet surface.

31. The apparatus of claim 28 wherein the dispensing member blocks the outlets not in fluid communication with the opening.

32. The apparatus of claim 31 further comprising a source for each confectionery material, the dispensing member further comprising a plurality of ports, each port corresponding to a respective outlet and respective source, each port placed in fluid communication with the corresponding outlet and corresponding source when the outlet is blocked.

33. The apparatus of claim 28 further comprising a conveyor for moving the continuous confectionery article.

34. The apparatus of claim 33 further comprising a controller in operative communication with the conveyor and the dispensing member, the controller coordinating the movement of the dispensing member and the movement of the conveyor.

35. The apparatus of claim 34 wherein the conveyor moves when the opening is in fluid communication with an outlet.

36. The apparatus of claim 34 wherein the conveyor stops when the opening is not in fluid communication with an outlet.

37. A method of making a confectionery article comprising:
providing a manifold containing a plurality of passageways, each passageway adapted to receive a respective plastic confectionery material, each passageway having an outlet on an outlet surface of the manifold and a dispensing member having an opening movably engaged to the outlet surface;
dispensing an amount of each confectionery material by sequentially placing the opening in fluid communication with each outlet; and
forming a continuous confectionery article having an amount of each confectionery material.

38. The method of claim 37 further comprising forming the continuous confectionery article with a repeating sequence of each confectionery material.

39. The method of claim 37 wherein each plastic confectionery material has a visually different property.

40. The method of claim 37 further comprising blocking with the dispensing member the outlets not in fluid communication with the opening.

41. The method of claim 40 wherein the dispensing member includes a plurality of ports, each port corresponding to a respective outlet, the method further comprising placing a respective port in fluid communication with a corresponding blocked outlet.

42. The method of claim 41 wherein each port is in fluid communication with a respective source of plastic confectionery material, the method further comprising placing, with the port, the outlet in fluid communication with the source of plastic confectionery material.

43. The method of claim 37 further comprising moving the continuous confectionery article with a conveyor.

44. The method of claim 43 further comprising halting the moving when the opening is not in fluid communication with an outlet.

45. The method of claim 37 further comprising rapidly sliding the dispensing member along the manifold outlet surface to sequentially place the opening in fluid communication with each outlet.

46. The method of claim 37 wherein the manifold contains first and second passageways with respective first and second outlets receiving respective first and second plastic confectionery materials, the first outlet disposed at a first position and the second outlet disposed at a second position, the method further comprising moving the opening between the first and second positions.

47. The method of claim 46 wherein the moving has a time duration from about 0.03 seconds to about 0.5 seconds.

48. A method of making a multiple phase confectionery article comprising:
providing a confectionery product having at least two strands of a confectionery material, each strand having a visually different property;
twisting the confectionery product about a longitudinal axis thereof to form a twisted confectionery product; and
pressing the twisted confectionery product to form a substantially flat confectionery article having an undulating pattern of strands.

49. The method of claim 48 wherein the at least two strands extend along the longitudinal axis.

50. The method of claim 48 further comprising coextruding the at least two strands.

51. A confectionery article comprising:
a substantially flat confectionery product having a width and a thickness, the confectionery product comprising at least two strands of a confectionery material extending across the width and through the thickness, each strand having a visually different property.

52. The confectionery article of claim 51 wherein the at least two strands further comprises from about 3 to about 10 strands.

53. The confectionery article of claim 51 wherein the at least two strands having a visually different property form a visual unit, the confectionery product further comprising a repeating sequence of two visual units to about 50 visual units.

54. The confectionery article of claim 51 wherein the visually different property is selected from the group consisting of color, surface texture, confectionery composition, and combinations thereof.

55. The confectionery article of claim 51 wherein each of the at least two strands has a different organoleptic property selected from the group consisting of flavor, aroma, softness, mouthfeel, and combinations thereof.

56. The confectionery article of claim 51 wherein the at least two strands are selected from the group consisting coextruded strands, welded strands, cohered strands, adhered strands, and combinations thereof.

57. The confectionery article of claim 51 wherein the confectionery material is selected from the group consisting of chewing gum, bubble gum, nougat, pliable confectionery material, taffy, chewy candy, caramel, and combinations thereof.

58. The confectionery article of claim 51 wherein the width is defined by a leading edge of the confectionery product, each strand substantially parallel to the leading edge.

59. The confectionery article of claim 51 wherein the product has a thickness from about 0.03 inches to about 2.0 inches and a length from about 1 foot to about 15 feet.

60. The confectionery article of claim 51 wherein each strand has a length from about 3 inches to about one foot.

61. The confectionery article of claim 51 wherein each strand has a width from about 0.25 inches to about 12 inches.

62. The confectionery article of claim 51 wherein each of the at least two strands is visible from the top, bottom, and sides of the confectionery product.

63. The confectionery article of claim 51 wherein the confectionery product is a rolled tape.

64. The confectionery article of claim 63 further comprising a dispenser, the rolled tape disposed in the dispenser.

65. The confectionery article of claim 63 further comprising two strands, each strand having a different color.

66. The confectionery article of claim 63 further comprising, three strands, each strand having a different color.

67. The confectionery article of claim 63 wherein each of the three strands has a different flavor.

68. The confectionery article of claim 63 wherein the confectionery article is chewing gum.

69. A multiple phase confectionery article comprising:
a substantially flat confectionery product having a thickness, the confectionery product comprising at least two strands of a confectionery material extending through the thickness of the confectionery product, each strand having a visually different property, the strands forming an undulating pattern in the confectionery product.

70. The confectionery article of claim 69 wherein the undulating pattern is selected from the group consisting of a swirl pattern, a random pattern, a twisted pattern, and a wavy pattern.

71. The confectionery article of claim 69 wherein the article has a width, each strand extending across the width of the article.

72. The confectionery article of claim 69 wherein each strand is visible from the top, the bottom, and at least one side of the confectionery article.

73. The confectionery article of claim 69 wherein the confectionery material is selected from the group consisting of chewing gum, bubble gum, nougat, pliable confectionery material, taffy, chewy candy, caramel, and combinations thereof.

74. The confectionery article of claim 69 wherein the confectionery article is rolled tape of chewing gum.
